(19) United States
(12) Patent Application Publication
(10) Pub. No.: US 2026/0197722 A1
(43) Pub. Date: Jul. 9, 2026

(54) RESOURCE MANAGEMENT METHOD AND APPARATUS IN COMMUNICATION SYSTEM INCLUDING NON-TERRESTRIAL NETWORK

(71) Applicants: HYUNDAI MOTOR COMPANY, Seoul (KR); KIA CORPORATION, Seoul (KR); INHA UNIVERSITY RESEARCH AND BUSINESS FOUNDATION, Incheon (KR)

(72) Inventors: Young Kil Suh, Hwaseong-si, Gyeonggi-do (KR); Gene Back Hahn, Hwaseong-si, Gyeonggi-do (KR); Ui Hyun Hong, Hwaseong-si, Gyeonggi-do (KR); Duk Kyung Kim, Hwaseong-si, Gyeonggi-do (KR)

(73) Assignees: HYUNDAI MOTOR COMPANY, Seoul (KR); KIA CORPORATION, Seoul (KR); INHA UNIVERSITY RESEARCH AND BUSINESS FOUNDATION, Incheon (KR)

(21) Appl. No.: 18/868,540

(22) PCT Filed: Jul. 10, 2023
(86) PCT No.: PCT/KR2023/009799

§ 371 Date: Nov. 22, 2024

(30) Foreign Application Priority Data
Jul. 8, 2022 (KR) 10-2022-0084255

(51) Int. Cl. H04W 36/00; H04B 7/185; H04W 24/10; H04W 72/0457

(52) U.S. Cl. CPC H04W 36/0058; H04B 7/18541; H04W 24/10; H04W 72/0457

(57) ABSTRACT

An operating method of a first terrestrial base station may comprise the steps of: receiving a first measurement report reported by a first terminal from a first satellite forming a first satellite cell; determining, by the first terminal, to access a second satellite cell formed by a second satellite connected to the first terrestrial base station; identifying, by the first satellite cell, n BWPs that were configured for the first terminal; attempting, by the second satellite cell, a configuration enabling a first BWP group among the n BWPs to be used for a service to the first terminal; and transmitting, to the first satellite, first configuration information including information generated on the basis of the step for determining and information generated on the basis of a result of the step for attempting.

### TECHNICAL FIELD

The present disclosure relates to a resource management technique in a communication system, and more particularly, to a handover management technique for improving efficiency of radio resource management in performing handover, cell switching, and the like.

### BACKGROUND ART

A communication network (e.g. 5G communication network, 6G communication network, etc.) to provide enhanced communication services compared to the existing communication network (e.g. long term evolution (LTE), LTE-Advanced (LTA-A), etc.) is being developed. The 5G communication network (e.g. new radio (NR) communication network) can support not only a frequency band of 6 GHz or below, but also a frequency band of 6 GHz or above. That is, the 5G communication network can support a frequency range (FR1) band and/or FR2 band. The 5G communication network can support various communication services and scenarios compared to the LTE communication network. For example, usage scenarios of the 5G communication network may include enhanced Mobile BroadBand (eMBB), Ultra Reliable Low Latency Communication (URLLC), Massive Machine Type Communication (mMTC), and the like.

The 6G communication network can support a variety of communication services and scenarios compared to the 5G communication network. The 6G communication networks can meet the requirements of hyper-performance, hyper-bandwidth, hyper-space, hyper-precision, hyper-intelligence, and/or hyper-reliability. The 6G communication networks can support various and wide frequency bands and can be applied to various usage scenarios (e.g. terrestrial communication, non-terrestrial communication, sidelink communication, and the like).

The communication network (e.g. 5G communication network, 6G communication network, etc.) may provide communication services to terminals located on the ground. Recently, the demand for communication services for not only terrestrial but also non-terrestrial airplanes, drones, and satellites has been increasing, and for this purpose, technologies for a non-terrestrial network (NTN) have been discussed. The non-terrestrial network may be implemented based on 5G communication technology, 6G communication technology, and/or the like. For example, in the non-terrestrial network, communication between a satellite and a terrestrial communication node or a non-terrestrial communication node (e.g. airplane, drone, or the like) may be performed based on 5G communication technology, 6G communication technology, and/or the like. In the NTN, the satellite may perform functions of a base station in a communication network (e.g. 5G communication network, 6G communication network, and/or the like).

In a handover process in a terrestrial network (TN) environment, radio resources such as bandwidth part(s) (BWP(s)) of a terminal for which a handover is requested may be newly configured in a target base station, and information on the newly configured BWP(s) may be delivered to the terminal through a serving base station. The terminal may use the provided BWP configuration information to proceed with a random access channel (RACH) process and subsequent connection establishment process with the target base station. Meanwhile, in the case of an NTN, a handover may occur due to movement of a satellite or NTN cell rather than movement of the terminal. Therefore, a handover in the NTN environment may be performed differently from that in the TN environment. For instance, when a handover occurs due to a new satellite entering a service area of an existing satellite, it may be preferable for the new satellite to maintain the same BWP configuration configured by the existing satellite for the terminal. Therefore, handover techniques that can improve the efficiency of BWP configurations and operations in the NTN environment may be required.

### DISCLOSURE

### Technical Problem

The present disclosure is directed to providing a resource management method and apparatus for improving efficiency of radio resource management in performing handover in a communication system including a non-terrestrial network.

### Technical Solution

A first exemplary embodiment of an operation method of a first terrestrial base station for achieving the above-described objective may comprise: receiving, from a first satellite forming a first satellite cell to which a first terminal is connected, a first measurement report reported by the first terminal; determining, based on the first measurement report, that the first terminal is to connect to a second satellite cell formed by a second satellite connected to the first terrestrial base station; identifying n bandwidth parts (BWPs) configured for the first terminal in the first satellite cell; attempting to configure a first BWP group including at least one BWP among the n BWPs to be used for serving the first terminal in the second satellite cell; and transmitting, to the first satellite, first configuration information including first BWP configuration information generated based on a result of the attempting and information instructing the first terminal to connect to the second satellite cell, wherein n is a natural number.

The first BWP group may include one first BWP, and the attempting may comprise: attempting to configure the first BWP to be used for serving the first terminal in the second satellite cell; and in response to the first BWP being successfully configured to be used for serving the first terminal, generating the first BWP configuration information including information indicating that the first BWP among the n BWPs configured for the first terminal in the first satellite cell is configured for serving the first terminal in the second satellite cell.

The operation method may further comprise: transmitting, to the first terminal, second configuration information instructing the first terminal to perform a BWP reconfiguration procedure with the second satellite cell for (n−1) BWPs excluding the first BWP among the n BWPs.

The first BWP group may include one first BWP, and the attempting may comprise: attempting to configure the first BWP to be used for serving the first terminal in the second satellite cell; in response to the first BWP failing to be configured to be used for serving the first terminal, performing BWP reconfiguration; and generating the first BWP configuration information indicating a result of the BWP reconfiguration.

The first BWP group may include m BWPs, and the attempting may comprise: attempting to configure k BWPs to be used for serving the first terminal in the second satellite cell; and in response to the k BWPs being successfully configured to be used for serving the first terminal, generating the first BWP configuration information including information on the k BWPs, wherein m is a natural number less than or equal to n, and k is a natural number less than or equal to m.

The m BWPs may be first to m-th BWPs selected based on BWP indices from among the n BWPs, and the first BWP configuration information may include respective indices of the first to m-th BWPs and mapping information of the first to m-th BWPs for the k BWPs.

The operation method may further comprise: transmitting, to the first terminal, third configuration information instructing the first terminal to perform a BWP reconfiguration procedure with the second satellite cell for (n-k) BWPs excluding the k BWPs among the n BWPs.

A second exemplary embodiment of an operation method of a first terrestrial base station for achieving the above-described objective may comprise: receiving, from a second terrestrial base station connected to a first satellite, a handover request for a first terminal connected to a first satellite cell formed by the first satellite connected to the first terrestrial base station; accepting a handover of the first terminal to a second satellite cell formed by the first satellite, based on the handover request; identifying n bandwidth parts (BWPs) configured for the first terminal in the first satellite cell, based on the handover request; attempting to configure a first BWP group including at least one BWP among the n BWPs to be used for serving the first terminal in the second satellite cell; and transmitting a first response to the second terrestrial base station, the first response including first BWP configuration information generated based on a result of the attempting and information indicating that the handover request for the first terminal is accepted, wherein n is a natural number.

The first BWP group may include one first BWP, and the attempting may comprise: attempting to configure the first BWP to be used for serving the first terminal in the second satellite cell; and in response to the first BWP being successfully configured to be used for serving the first terminal, generating the first BWP configuration information including information indicating that the first BWP among the n BWPs configured for the first terminal in the first satellite cell is configured for serving the first terminal in the second satellite cell.

The operation method may further comprise: transmitting, to the first terminal, second configuration information instructing the first terminal to perform a BWP reconfiguration procedure with the second satellite cell for (n−1) BWPs excluding the first BWP among the n BWPs.

The first BWP group may include one first BWP, and the attempting may comprise: attempting to configure the first BWP to be used for serving the first terminal in the second satellite cell; in response to the first BWP failing to be configured to be used for serving the first terminal, performing BWP reconfiguration; and generating the first BWP configuration information indicating a result of the BWP reconfiguration.

The first BWP group may include m BWPs, and the attempting may comprise: attempting to configure k BWPs to be used for serving the first terminal in the second satellite cell; and in response to the k BWPs being successfully configured to be used for serving the first terminal, generating the first BWP configuration information including information on the k BWPs, wherein m is a natural number less than or equal to n, and k is a natural number less than or equal to m.

The m BWPs may be first to m-th BWPs selected based on BWP indices from among the n BWPs, and the first BWP configuration information may include respective indices of the first to m-th BWPs and mapping information of the first to m-th BWPs for the k BWPs.

The operation method may further comprise: transmitting, to the first terminal, third configuration information instructing the first terminal to perform a BWP reconfiguration procedure with the second satellite cell for (n-k) BWPs excluding the k BWPs among the n BWPs.

A third exemplary embodiment of an operation method of a first terrestrial base station for achieving the above-described objective may comprise: receiving, from a second terrestrial base station, a handover request for a first terminal connected to a first satellite cell formed by a first satellite connected to the second terrestrial base station; accepting a handover of the first terminal to a second satellite cell formed by a second satellite connected to the second terrestrial base station, based on the handover request; identifying n bandwidth parts (BWPs) configured for the first terminal in the first satellite cell, based on the handover request; attempting to configure a first BWP group including at least one BWP among the n BWPs to be used for serving the first terminal in the second satellite cell; and transmitting a first response to the second terrestrial base station, the first response including first BWP configuration information generated based on a result of the attempting and information indicating that the handover request for the first terminal is accepted, wherein n is a natural number.

The first BWP group may include one first BWP, and the attempting may comprise: attempting to configure the first BWP to be used for serving the first terminal in the second satellite cell; and in response to the first BWP being successfully configured to be used for serving the first terminal, generating the first BWP configuration information including information indicating that the first BWP among the n BWPs configured for the first terminal in the first satellite cell is configured for serving the first terminal in the second satellite cell.

The operation method may further comprise: transmitting, to the first terminal, second configuration information instructing the first terminal to perform a BWP reconfiguration procedure with the second satellite cell for (n−1) BWPs excluding the first BWP among the n BWPs.

The first BWP group may include one first BWP, and the attempting may comprise: attempting to configure the first BWP to be used for serving the first terminal in the second satellite cell; in response to the first BWP failing to be configured to be used for serving the first terminal, performing BWP reconfiguration; and generating the first BWP configuration information indicating a result of the BWP reconfiguration.

The first BWP group may include m BWPs, and the attempting may comprise: attempting to configure k BWPs to be used for serving the first terminal in the second satellite cell; and in response to the k BWPs being successfully configured to be used for serving the first terminal, generating the first BWP configuration information including information on the k BWPs, wherein m is a natural number less than or equal to n, and k is a natural number less than or equal to m.

The m BWPs may be first to m-th BWPs selected based on BWP indices from among the n BWPs, and the first BWP configuration information may include respective indices of the first to m-th BWPs and mapping information of the first to m-th BWPs for the k BWPs.

### Advantageous Effects

According to exemplary embodiments of a resource management method and apparatus in a communication system including an NTN, a terminal connected to the NTN may move from a first satellite cell to a second satellite cell. Here, as the terminal moves from the first satellite cell to the second satellite cell, at least a portion of BWPs configured for the terminal in the first satellite cell may be identically configured in the second satellite cell. As BWP(s) that partially overlap with the previously used ones are configured during the terminal's cell movement process, overhead of configuring BWPs and signaling procedures for BWP information can be significantly reduced. Accordingly, the efficiency of the terminal's cell movement process can be improved.

### DESCRIPTION OF DRAWINGS

FIG. 1A is a conceptual diagram illustrating a first exemplary embodiment of a non-terrestrial network.

FIG. 1B is a conceptual diagram illustrating a second exemplary embodiment of a non-terrestrial network.

FIG. 2A is a conceptual diagram illustrating a third exemplary embodiment of a non-terrestrial network.

FIG. 2B is a conceptual diagram illustrating a fourth exemplary embodiment of a non-terrestrial network.

FIG. 2C is a conceptual diagram illustrating a fifth exemplary embodiment of a non-terrestrial network.

FIG. 3 is a block diagram illustrating a first exemplary embodiment of a communication node constituting a non-terrestrial network.

FIG. 4 is a block diagram illustrating a first exemplary embodiment of communication nodes performing communication.

FIG. 5A is a block diagram illustrating a first exemplary embodiment of a transmission path.

FIG. 5B is a block diagram illustrating a first exemplary embodiment of a reception path.

FIG. 6A is a conceptual diagram illustrating a first exemplary embodiment of a protocol stack of a user plane in a transparent payload-based non-terrestrial network.

FIG. 6B is a conceptual diagram illustrating a first exemplary embodiment of a protocol stack of a control plane in a transparent payload-based non-terrestrial network.

FIG. 7A is a conceptual diagram illustrating a first exemplary embodiment of a protocol stack of a user plane in a regenerative payload-based non-terrestrial network.

FIG. 7B is a conceptual diagram illustrating a first exemplary embodiment of a protocol stack of a control plane in a regenerative payload-based non-terrestrial network.

FIG. 8 is a conceptual diagram illustrating differences in handovers according to cell types in a non-terrestrial network (NTN).

FIG. 9 is a sequence chart illustrating an exemplary embodiment of a handover procedure in a terrestrial network (TN).

FIGS. 10A to 10C are conceptual diagrams describing exemplary embodiments of handover in NTN.

FIG. 11A and FIG. 11B are conceptual diagrams describing exemplary embodiments of a feeder link switching method in NTN.

FIG. 12 is a conceptual diagram describing a difference between a handover in TN and a handover in NTN.

FIG. 13 is a sequence chart describing a first exemplary embodiment of a resource management method in a communication system.

FIG. 14 is a sequence chart describing a second exemplary embodiment of a resource management method in a communication system.

FIG. 15 is a sequence chart describing a third exemplary embodiment of a resource management method in a communication system.

### MODE FOR INVENTION

While the present disclosure is capable of various modifications and alternative forms, specific embodiments thereof are shown by way of example in the drawings and will herein be described in detail. It should be understood, however, that there is no intent to limit the present disclosure to the particular forms disclosed, but on the contrary, the present disclosure is to cover all modifications, equivalents, and alternatives falling within the spirit and scope of the present disclosure. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present disclosure. As used herein, the term “and/or” includes any and all combinations of one or more of the associated listed items.

In the present disclosure, “at least one of A and B” may mean “at least one of A or B” or “at least one of combinations of one or more of A and B”. Also, in exemplary embodiments of the present disclosure, “one or more of A and B” may mean “one or more of A or B” or “one or more of combinations of one or more of A and B”.

In the present disclosure, “(re) transmission” may refer to “transmission”, “retransmission”, or “transmission and retransmission”, “(re) configuration” may refer to “configuration”, “reconfiguration”, or “configuration and reconfiguration”, “(re) connection” may refer to “connection”, “reconnection”, or “connection and reconnection”, and “(re) access” may mean “access”, “re-access”, or “access and re-access”.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present.

The terminology used herein is for the purpose of describing particular embodiments only and is not intended to be limiting of the present disclosure. As used herein, the singular forms are intended to include the plural forms as well, unless the context clearly indicates otherwise. It will be further understood that the terms “comprise” and/or “include” when used herein, specify the presence of stated features, integers, steps, operations, elements, components or combinations thereof, but do not preclude the presence or addition of one or more other features, integers, steps, operations, elements, components, and/or combinations thereof.

Unless otherwise defined, all terms (including technical and scientific terms) used herein have the same meaning as commonly understood by one of ordinary skill in the art to which this present disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, exemplary embodiments of the present disclosure will be described in greater detail with reference to the accompanying drawings. In order to facilitate general understanding in describing the present disclosure, the same components in the drawings are denoted with the same reference signs, and repeated description thereof will be omitted. In addition to the exemplary embodiments explicitly described in the present disclosure, operations may be performed according to a combination of the exemplary embodiments, extensions of the exemplary embodiments, and/or modifications of the exemplary embodiments. Performance of some operations may be omitted, and the order of performance of operations may be changed.

Even when a method (e.g. transmission or reception of a signal) performed at a first communication node among communication nodes is described, a corresponding second communication node may perform a method (e.g. reception or transmission of the signal) corresponding to the method performed at the first communication node. That is, when an operation of a user equipment (UE) is described, a base station corresponding to the UE may perform an operation corresponding to the operation of the UE. Conversely, when an operation of a base station is described, a UE corresponding to the base station may perform an operation corresponding to the operation of the base station. In a non-terrestrial network (NTN) (e.g. payload-based NTN), operations of a base station may refer to operations of a satellite, and operations of a satellite may refer to operations of a base station.

The base station may refer to a NodeB, evolved NodeB (eNodeB), next generation node B (gNodeB), gNB, device, apparatus, node, communication node, base transceiver station (BTS), radio remote head (RRH), transmission reception point (TRP), radio unit (RU), road side unit (RSU), radio transceiver, access point, access node, and/or the like. The UE may refer to a terminal, device, apparatus, node, communication node, end node, access terminal, mobile terminal, station, subscriber station, mobile station, portable subscriber station, on-broad unit (OBU), and/or the like.

In the present disclosure, signaling may be at least one of higher layer signaling, medium access control (MAC) signaling, or physical (PHY) signaling. Messages used for higher layer signaling may be referred to as ‘higher layer messages’ or ‘higher layer signaling messages’. Messages used for MAC signaling may be referred to as ‘MAC messages’ or ‘MAC signaling messages’. Messages used for PHY signaling may be referred to as ‘PHY messages’ or ‘PHY signaling messages’. The higher layer signaling may refer to a transmission and reception operation of system information (e.g. master information block (MIB), system information block (SIB)) and/or RRC messages. The MAC signaling may refer to a transmission and reception operation of a MAC control element (CE). The PHY signaling may refer to a transmission and reception operation of control information (e.g. downlink control information (DCI), uplink control information (UCI), and sidelink control information (SCI)).

In the present disclosure, “an operation (e.g. transmission operation) is configured” may mean that “configuration information (e.g. information element(s) or parameter(s)) for the operation and/or information indicating to perform the operation is signaled”. “Information element(s) (e.g. parameter(s)) are configured” may mean that “corresponding information element(s) are signaled”. In the present disclosure, “signal and/or channel” may mean a signal, a channel, or “signal and channel,” and “signal” may be used to mean “signal and/or channel”.

A communication system may include at least one of a terrestrial network, non-terrestrial network, 4G communication network (e.g. long-term evolution (LTE) communication network), 5G communication network (e.g. new radio (NR) communication network), or 6G communication network. Each of the 4G communications network, 5G communications network, and 6G communications network may include a terrestrial network and/or a non-terrestrial network. The non-terrestrial network may operate based on at least one communication technology among the LTE communication technology, 5G communication technology, or 6G communication technology. The non-terrestrial network may provide communication services in various frequency bands.

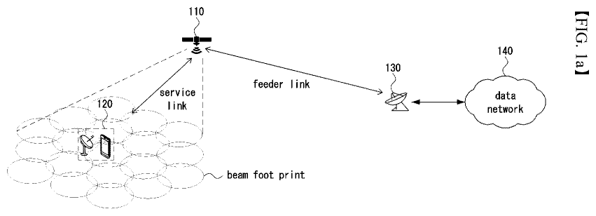

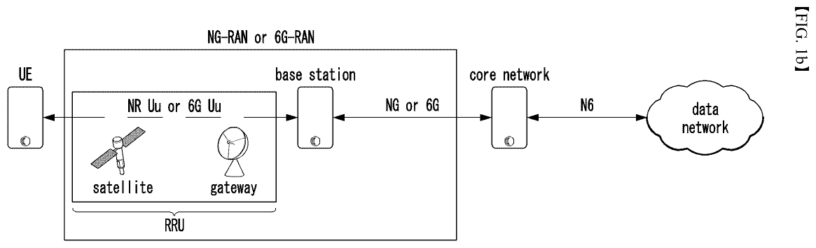

The communication network to which exemplary embodiments are applied is not limited to the content described below, and the exemplary embodiments may be applied to various communication networks (e.g. 4G communication network, 5G communication network, and/or 6G communication network). Here, a communication network may be used in the same sense as a communication system. FIG. 1A is a conceptual diagram illustrating a first exemplary embodiment of a non-terrestrial network.

As shown in FIG. 1A, a non-terrestrial network (NTN) may include a satellite 110, a communication node 120, a gateway 130, a data network 140, and the like. A unit including the satellite 110 and the gateway 130 may correspond to a remote radio unit (RRU). The NTN shown in FIG. 1A may be an NTN based on a transparent payload. The satellite 110 may be a low earth orbit (LEO) satellite, a medium earth orbit (MEO) satellite, a geostationary earth orbit (GEO) satellite, a high elliptical orbit (HEO) satellite, or an unmanned aircraft system (UAS) platform. The UAS platform may include a high altitude platform station (HAPS). A non-GEO satellite may be an LEO satellite and/or MEO satellite.

The communication node 120 may include a communication node (e.g. a user equipment (UE) or a terminal) located on a terrestrial site and a communication node (e.g. an airplane, a drone) located on a non-terrestrial space. A service link may be established between the satellite 110 and the communication node 120, and the service link may be a radio link. The satellite 110 may be referred to as an NTN payload. The gateway 130 may support a plurality of NTN payloads. The satellite 110 may provide communication services to the communication node 120 using one or more beams. The shape of a footprint of the beam of the satellite 110 may be elliptical or circular.

In the non-terrestrial network, three types of service links can be supported as follows.
Earth-fixed: a service link may be provided by beam(s) that continuously cover the same geographic area at all times (e.g. geosynchronous orbit (GSO) satellite).
quasi-earth-fixed: a service link may be provided by beam(s) covering one geographical area during a limited period and provided by beam(s) covering another geographical area during another period (e.g. non-GSO (NGSO) satellite forming steerable beams).
earth-moving: a service link may be provided by beam(s) moving over the Earth's surface (e.g. NGSO satellite forming fixed beams or non-steerable beams).

The communication node 120 may perform communications (e.g. downlink communication and uplink communication) with the satellite 110 using 4G communication technology, 5G communication technology, and/or 6G communication technology. The communications between the satellite 110 and the communication node 120 may be performed using an NR-Uu interface and/or 6G-Uu interface. When dual connectivity (DC) is supported, the communication node 120 may be connected to other base stations (e.g. base stations supporting 4G, 5G, and/or 6G functionality) as well as the satellite 110, and perform DC operations based on the techniques defined in 4G, 5G, and/or 6G technical specifications.

The gateway 130 may be located on a terrestrial site, and a feeder link may be established between the satellite 110 and the gateway 130. The feeder link may be a radio link. The gateway 130 may be referred to as a ‘non-terrestrial network (NTN) gateway’. The communications between the satellite 110 and the gateway 130 may be performed based on an NR-Uu interface, a 6G-Uu interface, or a satellite radio interface (SRI). The gateway 130 may be connected to the data network 140. There may be a ‘core network’ between the gateway 130 and the data network 140. In this case, the gateway 130 may be connected to the core network, and the core network may be connected to the data network 140. The core network may support the 4G communication technology, 5G communication technology, and/or 6G communication technology. For example, the core network may include an access and mobility management function (AMF), a user plane function (UPF), a session management function (SMF), and the like. The communications between the gateway 130 and the core network may be performed based on an NG-C/U interface or 6G-C/U interface.

As shown in an exemplary embodiment of FIG. 1B, there may be a ‘core network’ between the gateway 130 and the data network 140 in a transparent payload-based NTN.

FIG. 1B is a conceptual diagram illustrating a second exemplary embodiment of a non-terrestrial network.

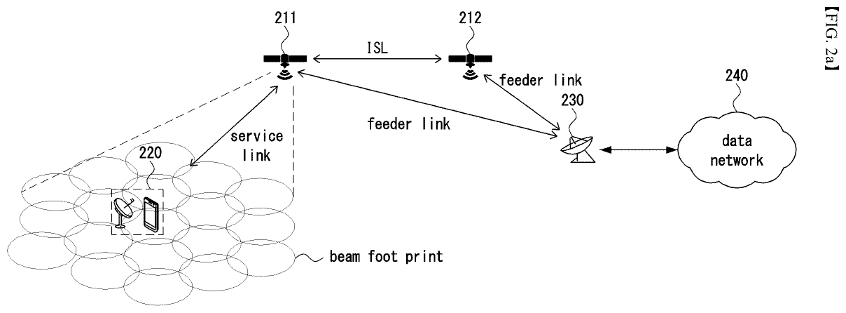

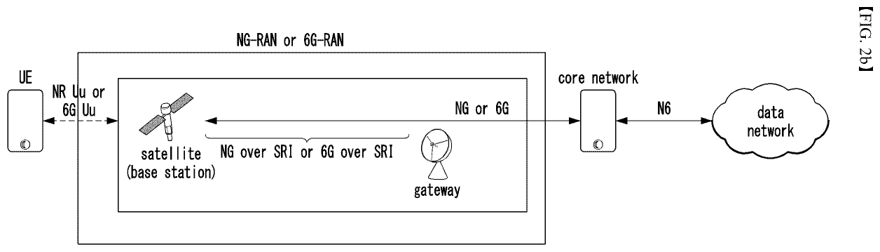

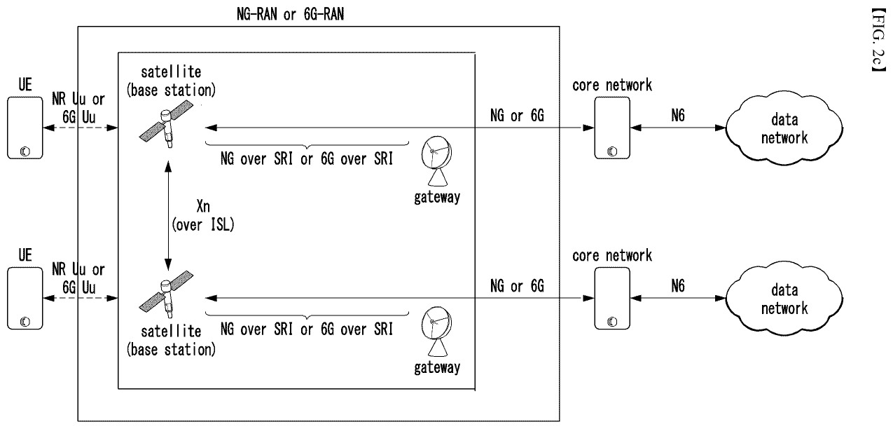

As shown in FIG. 1B, the gateway may be connected with the base station, the base station may be connected with the core network, and the core network may be connected with the data network. Each of the base station and core network may support the 4G communication technology, 5G communication technology, and/or 6G communication technology. The communications between the gateway and the base station may be performed based on an NR-Uu interface or 6G-Uu interface, and the communications between the base station and the core network (e.g. AMF, UPF, SMF, and the like) may be performed based on an NG-C/U interface or 6G-C/U interface. FIG. 2A is a conceptual diagram illustrating a third exemplary embodiment of a non-terrestrial network.

As shown in FIG. 2A, a non-terrestrial network may include a first satellite 211, a second satellite 212, a communication node 220, a gateway 230, a data network 240, and the like. The NTN shown in FIG. 2A may be a regenerative payload based NTN. For example, each of the satellites 211 and 212 may perform a regenerative operation (e.g. demodulation, decoding, re-encoding, re-modulation, and/or filtering operation) on a payload received from other entities (e.g. the communication node 220 or the gateway 230), and transmit the regenerated payload.

Each of the satellites 211 and 212 may be a LEO satellite, a MEO satellite, a GEO satellite, a HEO satellite, or a UAS platform. The UAS platform may include a HAPS. The satellite 211 may be connected to the satellite 212, and an inter-satellite link (ISL) may be established between the satellite 211 and the satellite 212. The ISL may operate in an RF frequency band or an optical band. The ISL may be established optionally. The communication node 220 may include a terrestrial communication node (e.g. UE or terminal) and a non-terrestrial communication node (e.g. airplane or drone). A service link (e.g. radio link) may be established between the satellite 211 and communication node 220. The satellite 211 may be referred to as an NTN payload. The satellite 211 may provide communication services to the communication node 220 using one or more beams.

The communication node 220 may perform communications (e.g. downlink communication or uplink communication) with the satellite 211 using the 4G communication technology, 5G communication technology, and/or 6G communication technology. The communications between the satellite 211 and the communication node 220 may be performed using an NR-Uu interface or 6G-Uu interface. When DC is supported, the communication node 220 may be connected to other base stations (e.g. base stations supporting 4G, 5G, and/or 6G functionality) as well as the satellite 211, and may perform DC operations based on the techniques defined in 4G, 5G, and/or 6G technical specifications.

The gateway 230 may be located on a terrestrial site, a feeder link may be established between the satellite 211 and the gateway 230, and a feeder link may be established between the satellite 212 and the gateway 230. The feeder link may be a radio link. When the ISL is not established between the satellite 211 and the satellite 212, the feeder link between the satellite 211 and the gateway 230 may be established mandatorily. The communications between each of the satellites 211 and 212 and the gateway 230 may be performed based on an NR-Uu interface, a 6G-Uu interface, or an SRI. The gateway 230 may be connected to the data network 240.

As shown in exemplary embodiments of FIG. 2B and FIG. 2C, there may be a ‘core network’ between the gateway 230 and the data network 240.

FIG. 2B is a conceptual diagram illustrating a fourth exemplary embodiment of a non-terrestrial network, and FIG. 2C is a conceptual diagram illustrating a fifth exemplary embodiment of a non-terrestrial network.

As shown in FIG. 2B and FIG. 2C, the gateway may be connected with the core network, and the core network may be connected with the data network. The core network may support the 4G communication technology, 5G communication technology, and/or 6G communication technology. For example. The core network may include AMF, UPF, SMF, and the like. Communication between the gateway and the core network may be performed based on an NG-C/U interface or 6G-C/U interface. Functions of a base station may be performed by the satellite. That is, the base station may be located on the satellite. The base station located on the satellite may be a base station-distributed unit (DU), and a base station-centralized unit (CU) may be located within NG-RAN or 6G-RAN. A payload may be processed by the base station located on the satellite. Base stations located on different satellites may be connected to the same core network. One satellite may have one or more base stations. In the non-terrestrial network of FIG. 2B, an ISL between satellites may not be established, and in the non-terrestrial network of FIG. 2C, an ISL between satellites may be established.

Meanwhile, the entities (e.g. satellite, base station, UE, communication node, gateway, and the like) constituting the non-terrestrial network shown in FIGS. 1A, 1B, 2A, 2B, and/or 2C may be configured as follows. In the present disclosure, the entity may be referred to as a communication node.

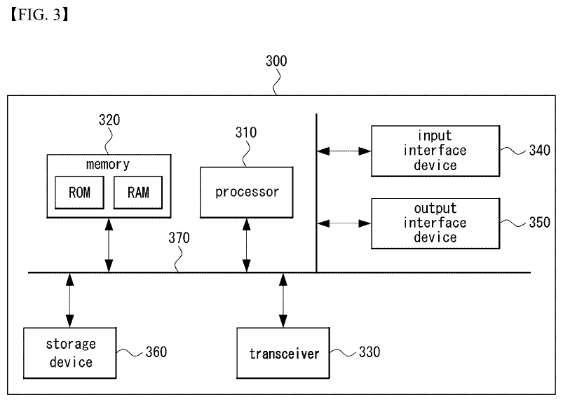

FIG. 3 is a block diagram illustrating a first exemplary embodiment of a communication node constituting a non-terrestrial network.

As shown in FIG. 3, a communication node 300 may include at least one processor 310, a memory 320, and a transceiver 330 connected to a network to perform communication. In addition, the communication node 300 may further include an input interface device 340, an output interface device 350, a storage device 360, and the like. The components included in the communication node 300 may be connected by a bus 370 to communicate with each other.

However, each component included in the communication node 300 may be connected to the processor 310 through a separate interface or a separate bus instead of the common bus 370. For example, the processor 310 may be connected to at least one of the memory 320, the transceiver 330, the input interface device 340, the output interface device 350, and the storage device 360 through a dedicated interface.

The processor 310 may execute at least one instruction stored in at least one of the memory 320 and the storage device 360. The processor 310 may refer to a central processing unit (CPU), a graphics processing unit (GPU), or a dedicated processor on which the methods according to the exemplary embodiments of the present disclosure are performed. Each of the memory 320 and the storage device 360 may be configured as at least one of a volatile storage medium and a nonvolatile storage medium. For example, the memory 320 may be configured with at least one of a read only memory (ROM) and a random access memory (RAM).

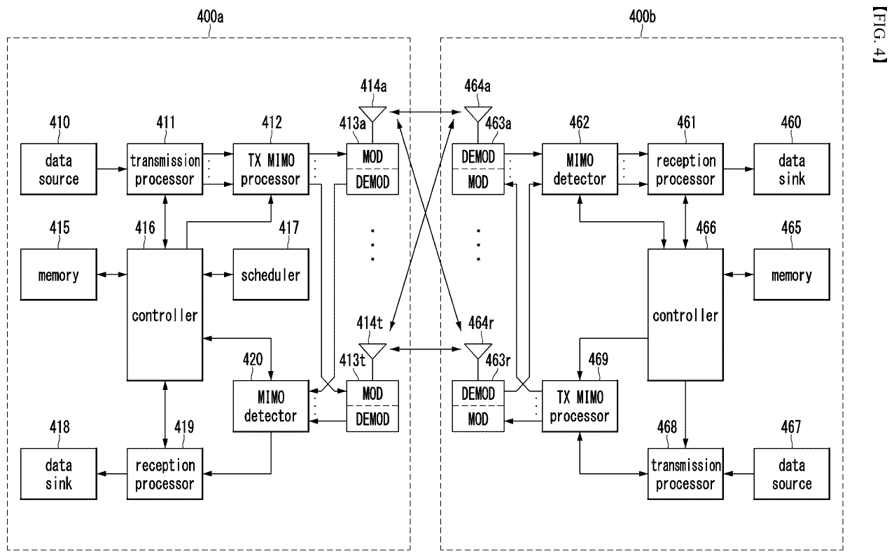

Meanwhile, communication nodes that perform communications in the communication network (e.g. non-terrestrial network) may be configured as follows. A communication node shown in FIG. 4 may be a specific exemplary embodiment of the communication node shown in FIG. 3.

FIG. 4 is a block diagram illustrating a first exemplary embodiment of communication nodes performing communication.

As shown in FIG. 4, each of a first communication node 400a and a second communication node 400b may be a base station or UE. The first communication node 400a may transmit a signal to the second communication node 400b. A transmission processor 411 included in the first communication node 400a may receive data (e.g. data unit) from a data source 410. The transmission processor 411 may receive control information from a controller 416. The control information may include at least one of system information, RRC configuration information (e.g. information configured by RRC signaling), MAC control information (e.g. MAC CE), or PHY control information (e.g. DCI, SCI).

The transmission processor 411 may generate data symbol(s) by performing processing operations (e.g. encoding operation, symbol mapping operation, etc.) on the data. The transmission processor 411 may generate control symbol(s) by performing processing operations (e.g. encoding operation, symbol mapping operation, etc.) on the control information. In addition, the transmission processor 411 may generate synchronization/reference symbol(s) for synchronization signals and/or reference signals.

A Tx MIMO processor 412 may perform spatial processing operations (e.g. precoding operations) on the data symbol(s), control symbol(s), and/or synchronization/reference symbol(s). An output (e.g. symbol stream) of the Tx MIMO processor 412 may be provided to modulators (MODs) included in transceivers 413a to 413t. The modulator may generate modulation symbols by performing processing operations on the symbol stream, and may generate signals by performing additional processing operations (e.g. analog conversion operations, amplification operation, filtering operation, up-conversion operation, etc.) on the modulation symbols. The signals generated by the modulators of the transceivers 413a to 413t may be transmitted through antennas 414a to 414t.

The signals transmitted by the first communication node 400a may be received at antennas 464a to 464r of the second communication node 400b. The signals received at the antennas 464a to 464r may be provided to demodulators (DEMODs) included in transceivers 463a to 463r. The demodulator (DEMOD) may obtain samples by performing processing operations (e.g. filtering operation, amplification operation, down-conversion operation, digital conversion operation, etc.) on the signals. The demodulator may perform additional processing operations on the samples to obtain symbols. A MIMO detector 462 may perform MIMO detection operations on the symbols. A reception processor 461 may perform processing operations (e.g. de-interleaving operation, decoding operation, etc.) on the symbols. An output of the reception processor 461 may be provided to a data sink 460 and a controller 466. For example, the data may be provided to the data sink 460 and the control information may be provided to the controller 466.

On the other hand, the second communication node 400b may transmit signals to the first communication node 400a. A transmission processor 469 included in the second communication node 400b may receive data (e.g. data unit) from a data source 467 and perform processing operations on the data to generate data symbol(s). The transmission processor 468 may receive control information from the controller 466 and perform processing operations on the control information to generate control symbol(s). In addition, the transmission processor 468 may generate reference symbol(s) by performing processing operations on reference signals.

A Tx MIMO processor 469 may perform spatial processing operations (e.g. precoding operations) on the data symbol(s), control symbol(s), and/or reference symbol(s). An output (e.g. symbol stream) of the Tx MIMO processor 469 may be provided to modulators (MODs) included in the transceivers 463a to 463t. The modulator may generate modulation symbols by performing processing operations on the symbol stream, and may generate signals by performing additional processing operations (e.g. analog conversion operation, amplification operation, filtering operation, up-conversion operations) on the modulation symbols. The signals generated by the modulators of the transceivers 463a to 463t may be transmitted through the antennas 464a to 464t.

The signals transmitted by the second communication node 400b may be received at the antennas 414a to 414r of the first communication node 400a. The signals received at the antennas 414a to 414r may be provided to demodulators (DEMODs) included in the transceivers 413a to 413r. The demodulator may obtain samples by performing processing operations (e.g. filtering operation, amplification operation, down-conversion operation, digital conversion operation) on the signals. The demodulator may perform additional processing operations on the samples to obtain symbols. A MIMO detector 420 may perform a MIMO detection operation on the symbols. The reception processor 419 may perform processing operations (e.g. de-interleaving operation, decoding operation, etc.) on the symbols. An output of the reception processor 419 may be provided to a data sink 418 and the controller 416. For example, the data may be provided to the data sink 418 and the control information may be provided to the controller 416.

Memories 415 and 465 may store the data, control information, and/or program codes. A scheduler 417 may perform scheduling operations for communication. The processors 411, 412, 419, 461, 468, and 469 and the controllers 416 and 466 shown in FIG. 4 may be the processor 310 shown in FIG. 3, and may be used to perform methods described in the present disclosure.

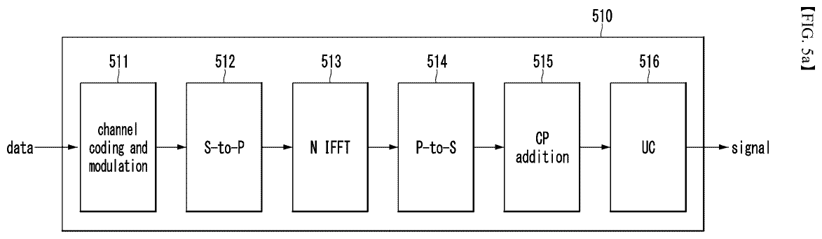

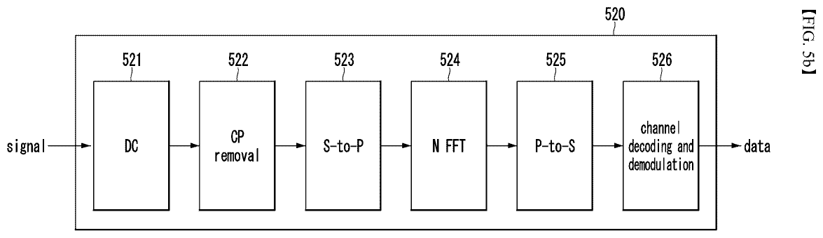

FIG. 5A is a block diagram illustrating a first exemplary embodiment of a transmission path, and FIG. 5B is a block diagram illustrating a first exemplary embodiment of a reception path.

As shown in FIGS. 5A and 5B, a transmission path 510 may be implemented in a communication node that transmits signals, and a reception path 520 may be implemented in a communication node that receives signals. The transmission path 510 may include a channel coding and modulation block 511, a serial-to-parallel (S-to-P) block 512, an N-point inverse fast Fourier transform (N-point IFFT) block 513, a parallel-to-serial (P-to-S) block 514, a cyclic prefix (CP) addition block 515, and up-converter (UC) 516. The reception path 520 may include a down-converter (DC) 521, a CP removal block 522, an S-to-P block 523, an N-point FFT block 524, a P-to-S block 525, and a channel decoding and demodulation block 526. Here, N may be a natural number.

In the transmission path 510, information bits may be input to the channel coding and modulation block 511. The channel coding and modulation block 511 may perform a coding operation (e.g. low-density parity check (LDPC) coding operation, polar coding operation, etc.) and a modulation operation (e.g. Quadrature Phase Shift Keying (OPSK), Quadrature Amplitude Modulation (QAM), etc.) on the information bits. An output of the channel coding and modulation block 511 may be a sequence of modulation symbols.

The S-to-P block 512 may convert frequency domain modulation symbols into parallel symbol streams to generate N parallel symbol streams. N may be the IFFT size or the FFT size. The N-point IFFT block 513 may generate time domain signals by performing an IFFT operation on the N parallel symbol streams. The P-to-S block 514 may convert the output (e.g., parallel signals) of the N-point IFFT block 513 to serial signals to generate the serial signals.

The CP addition block 515 may insert a CP into the signals. The UC 516 may up-convert a frequency of the output of the CP addition block 515 to a radio frequency (RF) frequency. Further, the output of the CP addition block 515 may be filtered in baseband before the up-conversion.

The signal transmitted from the transmission path 510 may be input to the reception path 520. Operations in the reception path 520 may be reverse operations for the operations in the transmission path 510. The DC 521 may down-convert a frequency of the received signals to a baseband frequency. The CP removal block 522 may remove a CP from the signals. The output of the CP removal block 522 may be serial signals. The S-to-P block 523 may convert the serial signals into parallel signals. The N-point FFT block 524 may generate N parallel signals by performing an FFT algorithm. The P-to-S block 525 may convert the parallel signals into a sequence of modulation symbols. The channel decoding and demodulation block 526 may perform a demodulation operation on the modulation symbols and may restore data by performing a decoding operation on a result of the demodulation operation.

In FIGS. 5A and 5B, discrete Fourier transform (DFT) and inverse DFT (IDFT) may be used instead of FFT and IFFT. Each of the blocks (e.g. components) in FIGS. 5A and 5B may be implemented by at least one of hardware, software, or firmware. For example, some blocks in FIGS. 5A and 5B may be implemented by software, and other blocks may be implemented by hardware or a combination of hardware and software. In FIGS. 5A and 5B, one block may be subdivided into a plurality of blocks, a plurality of blocks may be integrated into one block, some blocks may be omitted, and blocks supporting other functions may be added.

Meanwhile, NTN reference scenarios may be defined as shown in Table 1 below.

TABLE 1

| | NTN shown in FIG. 1 | NTN shown in FIG. 2 |
|---|---|---|
| GEO | Scenario A | Scenario B |
| LEO (steerable | Scenario C1 | Scenario D1 |
| beams) | | |
| LEO (beams | Scenario C2 | Scenario D2 |
| moving with | | |
| satellite) | | |

When the satellite 110 in the NTN shown in FIG. 1A and/or FIG. 1B is a GEO satellite (e.g. a GEO satellite that supports a transparent function), this may be referred to as ‘scenario A’. When the satellites 211 and 212 in the NTN shown in FIG. 2A, FIG. 2B, and/or FIG. 2C are GEO satellites (e.g. GEOs that support a regenerative function), this may be referred to as ‘scenario B’.

When the satellite 110 in the NTN shown in FIG. 1A and/or FIG. 1B is an LEO satellite with steerable beams, this may be referred to as ‘scenario C1’. When the satellite 110 in the NTN shown in FIG. 1A and/or FIG. 1B is an LEO satellite having beams moving with the satellite, this may be referred to as ‘scenario C2’. When the satellites 211 and 212 in the NTN shown in FIG. 2A, FIG. 2B, and/or FIG. 2C are LEO satellites with steerable beams, this may be referred to as ‘scenario D1’. When the satellites 211 and 212 in the NTN shown in FIG. 2A, FIG. 2B, and/or FIG. 2C are LEO satellites having beams moving with the satellites, this may be referred to as ‘scenario D2’.

Parameters for the NTN reference scenarios defined in Table 1 may be defined as shown in Table 2 below.

TABLE 2

| | Scenarios A and B | Scenarios C and D |
|---|---|---|
| Altitude | 35,786 km | 600 km |
| | | 1,200 km |
| Spectrum (service link) | <6 GHz (e.g. 2 GHz) | |
| | >6 GHz (e.g. DL 20 GHz, UL 30 GHz) | |
| Maximum channel bandwidth | 30 MHz for band <6 GHz | |
| capability (service link) | 1 GHz for band >6 GHz | |
| Maximum distance between | 40,581 km | 1,932 km (altitude of |
| satellite and communication | | 600 km) |
| node (e.g. UE) at the | | 3,131 km (altitude of |
| minimum elevation angle | | 1,200 km) |
| Maximum round trip delay | Scenario A: 541.46 ms | Scenario C: |
| (RTD) (only propagation | (service and feeder links) | (transparent payload: |
| delay) | Scenario B: 270.73 ms | service and feeder links) |
| | (only service link) | −5.77 ms (altitude of |
| | | 60 0 km) |
| | | −41.77 ms (altitude of |
| | | 1,200 km) |
| | | Scenario D: |
| | | (regenerative payload: |
| | | only service link) |
| | | −12.89 ms (altitude of |
| | | 600 km) |
| | | −20.89 ms (altitude of |
| | | 1,200 km) |
| Maximum differential | 10.3 ms | 3.12 ms (altitude of |
| delay within a cell | | 600 km) |
| | | 3.18 ms (altitude of |
| | | 1,200 km) |

| | |
|---|---|
| Service link | NR defined in 3GPP |
| Feeder link | Radio interfaces defined in 3GPP or non-3GPP |

In addition, in the scenarios defined in Table 1, delay constraints may be defined as shown in Table 3 below.

TABLE 3

| | | | Scenario | Scenario |
|---|---|---|---|---|
| | Scenario A | Scenario B | C1-2 | D1-2 |
| Satellite altitude | 35,786 km | | 600 km | |
| Maximum RTD in a | 541.75 ms | 270.57 ms | 28.41 ms | 12.88 ms |
| radio interface | (worst case) | | | |
| between base station | | | | |
| and UE | | | | |
| Minimum RTD in a | 477.14 ms | 238.57 ms | 8 ms | 4 ms |
| radio interface | | | | |
| between base station | | | | |
| and UE | | | | |

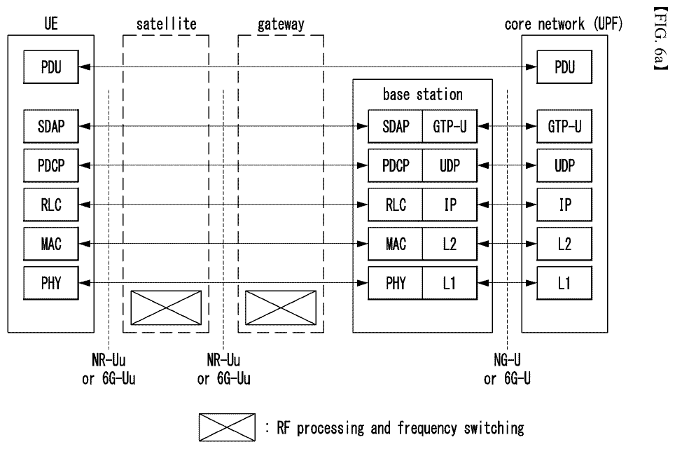

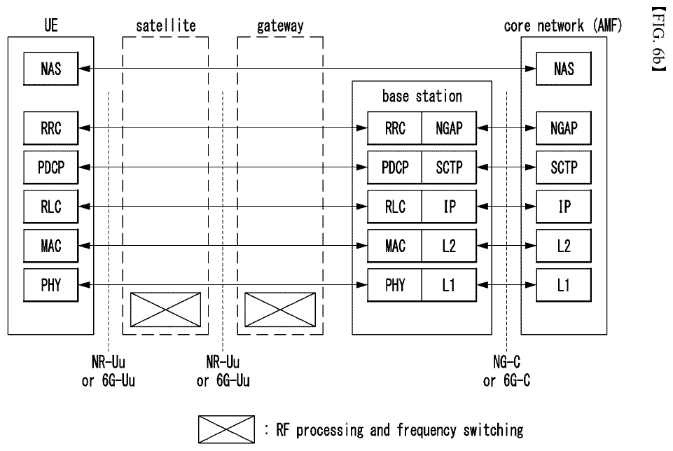

FIG. 6A is a conceptual diagram illustrating a first exemplary embodiment of a protocol stack of a user plane in a transparent payload-based non-terrestrial network, and FIG. 6B is a conceptual diagram illustrating a first exemplary embodiment of a protocol stack of a control plane in a transparent payload-based non-terrestrial network.

As shown in FIGS. 6A and 6B, user data may be transmitted and received between a UE and a core network (e.g. UPF), and control data (e.g. control information) may be transmitted and received between the UE and the core network (e.g. AMF). Each of the user data the and control data may be transmitted and received through a satellite and/or gateway. The protocol stack of the user plane shown in FIG. 6A may be applied identically or similarly to a 6G communication network. The protocol stack of the control plane shown in FIG. 6B may be applied identically or similarly to a 6G communication network.

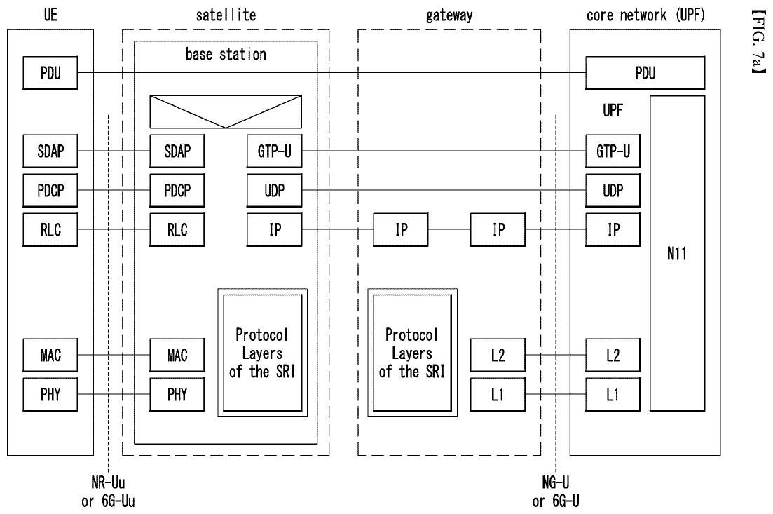

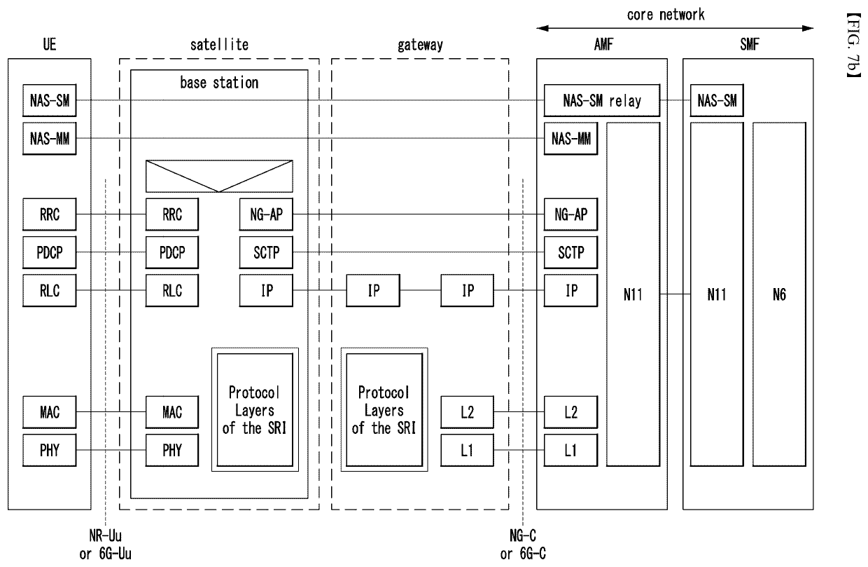

FIG. 7A is a conceptual diagram illustrating a first exemplary embodiment of a protocol stack of a user plane in a regenerative payload-based non-terrestrial network, and FIG. 7B is a conceptual diagram illustrating a first exemplary embodiment of a protocol stack of a control plane in a regenerative payload-based non-terrestrial network.

As shown in FIGS. 7A and 7B, each of user data and control data (e.g. control information) may be transmitted and received through an interface between a UE and a satellite (e.g. base station). The user data may refer to a user protocol data unit (PDU). A protocol stack of a satellite radio interface (SRI) may be used to transmit and receive the user data and/or control data between the satellite and a gateway. The user data may be transmitted and received through a general packet radio service (GPRS) tunneling protocol (GTP)-U tunnel between the satellite and a core network.

Meanwhile, in a non-terrestrial network, a base station may transmit system information (e.g. SIB19) including satellite assistance information for NTN access. A UE may receive the system information (e.g. SIB19) from the base station, identify the satellite assistance information included in the system information, and perform communication (e.g. non-terrestrial communication) based on the satellite assistance information. The SIB19 may include information element(s) defined in Table 4 below.

TABLE 4
SIB19-r17 ::= SEQUENCE {

| | |
|---|---|
| ntn-Config-r17 | NTN-Config-r17 |
| t-Service-r17 | INTEGER(0..549755813887) |
| referenceLocation-r17 | ReferenceLocation-r17 |
| distanceThresh-r17 | INTEGER(0..65525) |
| ntn-NeighCellConfigList-r17 | NTN-NeighCellConfigList-r17 |
| lateNonCriticalExtension | OCTET STRING |

```
  ...,
  [[
```

| | |
|---|---|
| ntn-NeighCellConfigListExt-v1720 | NTN-NeighCellConfigList-r17 |

]]
}

| | |
|---|---|
| NTN-NeighCellConfigList-r17 ::= | SEQUENCE (SIZE(1..maxCellNTN-r17)) |

OF NTN-NeighCellConfig-r17

| | |
|---|---|
| NTN-NeighCellConfig-r17 ::= | SEQUENCE { |
| ntn-Config-r17 | NTN-Config-r17 |
| carrierFreq-r17 | ARFCN-ValueNR |
| physCellId-r17 | PhysCellId |

}

NTN-Config defined in Table 4 may include information element(s) defined in Table 5 below.

TABLE 5

| | |
|---|---|
| NTN-Config-r17 ::= | SEQUENCE { |
| epochTime-r17 | EpochTime-r17 |
| ntn-UlSyncValidityDuration-r17 | ENUMERATED{ s5, s10, s15, s20, s25, s30, s35, |

s40, s45, s50, s55, s60, s120, s180, s240, s900}

| | |
|---|---|
| cellSpecificKoffset-r17 | INTEGER(1..1023) |
| kmac-r17 | INTEGER(1..512) |
| ta-Info-r17 | TA-Info-r17 |
| ntn-PolarizationDL-r17 | ENUMERATED {rhcp,lhcp,linear} |
| ntn-PolarizationUL-r17 | ENUMERATED {rhcp,lhcp,linear} |
| ephemerisInfo-r17 | EphemerisInfo-r17 |
| ta-Report-r17 | ENUMERATED {enabled} |

...
}

| | |
|---|---|
| EpochTime-r17 ::= | SEQUENCE { |
| sfn-r17 | INTEGER(0..1023), |
| subFrameNR-r17 | INTEGER(0..9) |

}

| | |
|---|---|
| TA-Info-r17 ::= | SEQUENCE { |
| ta-Common-r17 | INTEGER(0..66485757), |
| ta-CommonDrift-r17 | INTEGER(−257303..257303) |
| ta-CommonDriftVariant-r17 | INTEGER(0..28949) |

}

EphemerisInfo defined in Table 5 may include information element(s) defined in Table 6 below.

TABLE 6

| | |
|---|---|
| EphemerisInfo-r17 ::= | CHOICE { |
| positionVelocity-r17 | PositionVelocity-r17, |
| orbital-r17 | Orbital-r17 |

}

| | |
|---|---|
| PositionVelocity-r17 ::= | SEQUENCE { |
| positionX-r17 | PositionStateVector-r17, |
| positionY-r17 | PositionStateVector-r17, |
| positionZ-r17 | PositionStateVector-r17, |
| velocityVX-r17 | VelocityStateVector-r17, |
| velocityVY-r17 | VelocityStateVector-r17, |
| velocityVZ-r17 | VelocityStateVector-r17 |

}

| | |
|---|---|
| Orbital-r17 ::= | SEQUENCE { |
| semiMajorAxis-r17 | INTEGER (0..8589934591), |
| eccentricity-r17 | INTEGER (0..1048575), |
| periapsis-r17 | INTEGER (0..268435455), |
| longitude-r17 | INTEGER (0..268435455), |
| inclination-r17 | INTEGER (−67108864..67108863), |
| meanAnomaly-r17 | INTEGER (0..268435455) |

}
PositionStateVector-r17 ::= INTEGER (−33554432..33554431)
VelocityStateVector-r17 ::= INTEGER (−131072..131071)

Hereinafter, resource management methods in a communication system including a non-terrestrial network will be described. Even when a method (e.g. transmission or reception of a signal) performed by a first communication node among communication nodes is described, a corresponding second communication node may perform a method corresponding to that of the first communication node (e.g. reception or transmission of a signal). That is, when an operation of a terminal is described, a corresponding base station (or satellite) may perform an operation corresponding to that of the terminal. Conversely, when an operation of a base station (or satellite) is described, a corresponding terminal may perform an operation corresponding to that of the base station (or satellite).

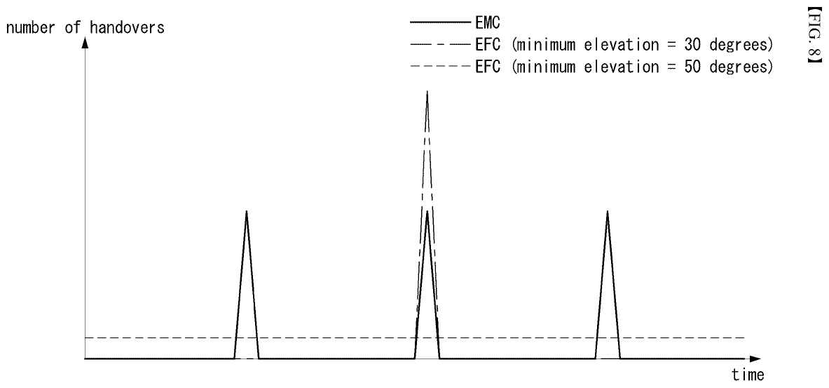

FIG. 8 is a conceptual diagram illustrating differences in handovers according to cell types in a non-terrestrial network (NTN).

As shown in FIG. 8, a communication system may be configured to include a non-terrestrial network (NTN) and/or a terrestrial network (TN). For example, the communication system may include an NTN configured to provide services to a predetermined coverage, including one or more satellites and one or more gateways. Here, the NTN may be identical to or similar to at least one of the exemplary embodiments of the NTN described with reference to FIGS. 1A to 7B. Hereinafter, in describing differences in handovers according to cell types in the NTN with reference to FIG. 8, descriptions redundant with those described with reference to FIGS. 1 to 7B may be omitted.

The NTN may support earth-fixed cells (EFCs) (or earth-fixed service links). The EFC may be formed based on a geostationary satellite. The NTN may support earth-moving cells (EMCs) (or earth-moving service links). The EMC may be formed based on a non-geostationary satellite (i.e. moving satellite).

In the case of EMC, handovers may occur continuously according to movement of the satellite. That is, in the EMC-based NTN, a frequency of handovers occurring over time may be relatively uniform. On the other hand, in the case of EFC, rather than handovers occurring continuously, a large number of handovers may be simultaneously required for a short period of time. For example, in the EFC-based NTN, the number of handovers that need to be executed in a short period of time when cell switching occurs may periodically reach a peak or burst. This phenomenon may be more pronounced as an altitude of the satellite increases.

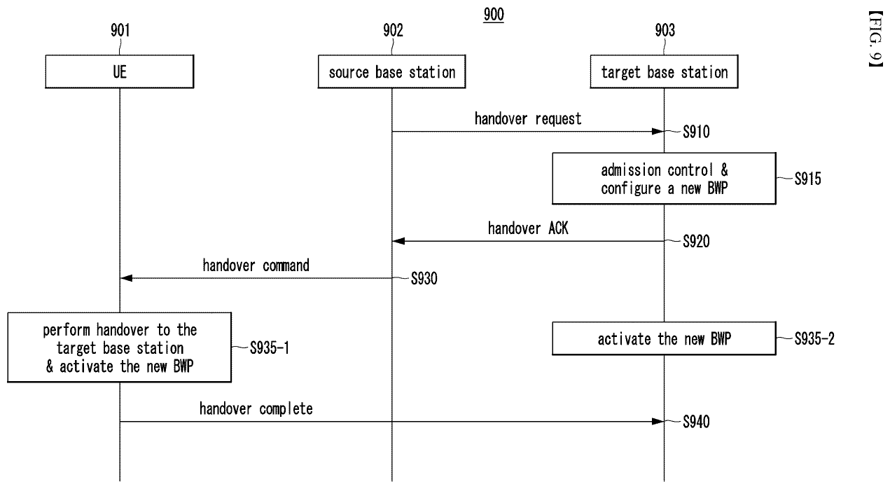

FIG. 9 is a sequence chart illustrating an exemplary embodiment of a handover procedure in a terrestrial network (TN).

As shown in FIG. 9, a communication system may be configured to include an NTN and/or a TN. For example, the communication system may include a TN configured to provide services to a predetermined coverage based on one or more terrestrial base stations (e.g. gNBs). Hereinafter, in describing an exemplary embodiment of a handover procedure in the TN with reference to FIG. 9, descriptions redundant with those described with reference to FIGS. 1 to 8 may be omitted.

In the communication system 900 including the TN, a user equipment (UE) 901 may be connected to a source base station 902. Here, a handover procedure in which the UE 901 moves from the source base station 902 to a target base station 903 may be performed. Such a handover procedure may be triggered or initiated by at least one node among the UE 901, the source base station 902, and the target base station 903.

For example, the source base station 902 may trigger or initiate the handover procedure. The source base station 902 may transmit a handover request message to the target base station 903 (S910). The target base station 903 may receive the handover request message transmitted from the source base station 902 (S910). In step S910, the handover request message may be transmitted and received via an Xn interface, etc. In step S910, the handover request message may be transmitted based on a measurement report from the UE 901.

The target base station 903 may perform admission control based on the handover request message (S915). In step S915, the target base station 903 may newly configure radio resources such as BWP(s) for the UE 901. The BWP(s) configured by the target base station 903 for the UE 901 in step S915 may be the same as or different from BWP(s) configured or allocated by the source base station 902 for the UE 901.

The target base station 903 may transmit a handover acknowledgment (ACK) message to the source base station 902 (S920). The target base station 903 may provide radio resource control (RRC) configuration. The target base station 903 may provide information on the new BWP(s) configured in step S915 to the source base station 902 through the handover ACK message. The source base station 902 may receive the handover ACK message transmitted by the target base station 903 (S920).

The source base station 902 may transmit a handover command message to the UE 901 based on the handover ACK message transmitted from the target base station 903 (S930). The UE 901 may receive the handover command message transmitted from the source base station 902 (S930). The handover command message transmitted in step S930 may include all information required for at least the UE 901 to access a cell of the target base station 903. Accordingly, the UE 901 may access a cell of the target base station 903 based on the handover command message without reading system information of the cell of the target base station 903. For example, the handover command message may include information required for contention-based random access or contention-free random access. The handover command message may include information of the new BWP(s) configured by the target base station 903 in step S915.

The UE 901 may perform a handover to the target base station 903 based on the handover command message transmitted from the source base station 902 (S935-1). In other words, the UE 901 may move RRC connection to the target base station 903 or its cell. Here, configuration of the new BWP(s) configured in step S915 may be activated. Configuration of the new BWP(s) configured in step S915 may also be activated in the target base station 903 (S935-2).

The UE 901 may transmit a handover complete message to the target base station 903 (S940). The target base station 903 may receive the handover complete message transmitted from the UE 901 (S940). Thus, the handover procedure may be completed.

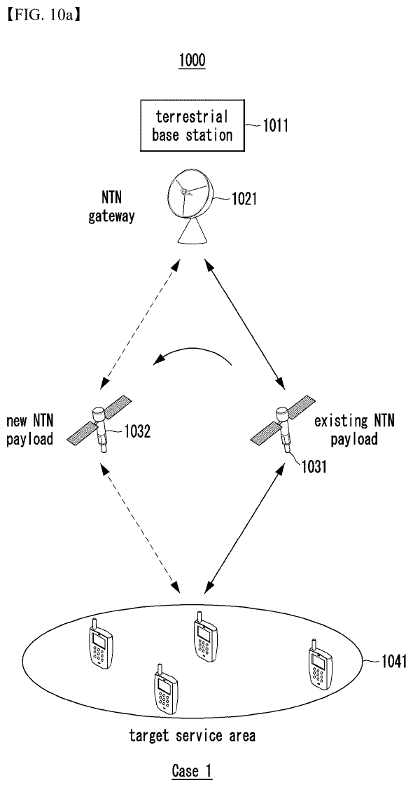

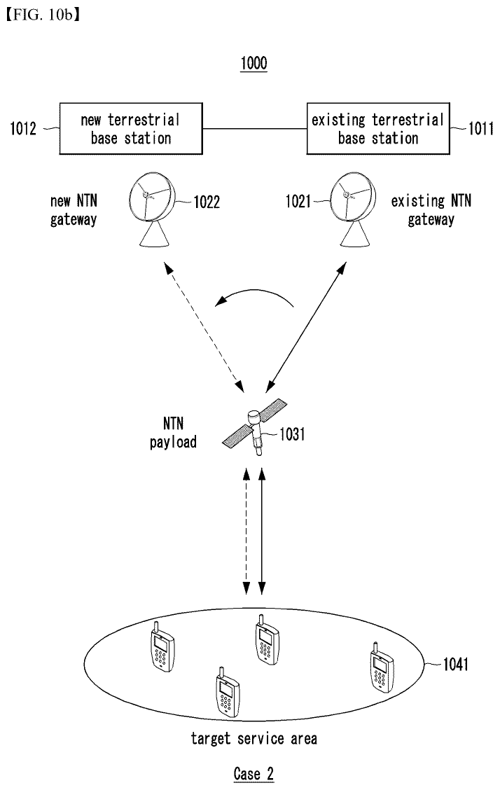

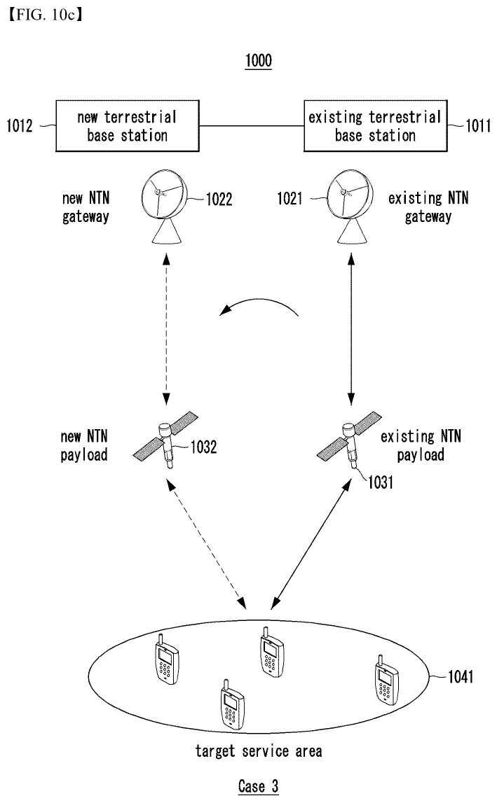

FIGS. 10A to 10C are conceptual diagrams describing exemplary embodiments of handover in NTN.

As shown in FIGS. 10A to 10C, a communication system may be configured to include an NTN and/or a TN. For example, the communication system may include an NTN configured to provide services to a predetermined coverage, including one or more satellites and one or more gateways. Here, the NTN may be identical to or similar to at least one of the exemplary embodiments of the NTN described with reference to FIGS. 1A to 7B. Hereinafter, in describing exemplary embodiments of handover in the NTN with reference to FIGS. 10A to 10C, descriptions redundant with those described with reference to FIGS. 1 to 9 may be omitted.

In the NTN, users or UEs may be connected to an NTN gateway based on an NTN satellite or NTN payload satellite, and may be connected to a terrestrial base station (e.g. gNB) based on the NTN gateway. Handover scenarios for NTN may be classified into intra-satellite handover, inter-satellite handover, and inter-access handover. The intra-satellite handover may occur between cells served by the same satellite. The inter-satellite handover may occur between cells served by different satellites. The inter-access handover may occur between cellular access and satellite access. In the case of a transparent payload-based satellite (e.g. satellite supporting transparent functions), an intra-gNB handover and/or inter-gNB handover may occur. The configurations described for ‘gNB’ in the present disclosure may be replaced with configurations for ‘terrestrial base station’.

A handover case 1 illustrated in FIG. 10A may correspond to an exemplary embodiment of inter-satellite/intra-gNB handover. Users or UEs within a target service area 1041 may move from an existing NTN payload satellite 1031 to a new NTN payload satellite 1032. Here, the existing NTN payload satellite 1031 and the new NTN payload satellite 1032 may be satellites connected to the same terrestrial base station 1011 via the same NTN gateway 1021. Cell movement (or change) according to the handover case 1 may also be referred to as ‘cell switching’ or ‘service link switching’.

A handover case 2 illustrated in FIG. 10B may correspond to an exemplary embodiment of an intra-satellite/inter-gNB handover. Users or UEs within the target service area 1041 may be served through a new cell of the same NTN payload satellite 1031. The NTN payload satellite 1031, which was connected to an existing terrestrial base station 1011 through an existing NTN gateway 1021, may be connected to a new terrestrial base station 1012 through a new NTN gateway 1022. In other words, a feeder link of the NTN payload satellite 1031 may be switched from the existing terrestrial base station 1011 to the new terrestrial base station 1012.

A handover case 3 illustrated in FIG. 10C may correspond to an exemplary embodiment of an inter-satellite/inter-gNB handover. Users or UEs within the target service area 1041 may move from an existing NTN payload satellite 1031 to a new NTN payload satellite 1032. Here, the existing NTN payload satellite 1031 and the new NTN payload satellite 1032 may be satellites connected to different terrestrial base stations 1011 and 1012 through different NTN gateways 1021 and 1022. That is, in the handover case 3, both the satellite and the terrestrial base station to which the users (or UEs) are connected may be switched.

In a transparent payload-based NTN, a handover may or may not involve feeder link switching. For example, in the handover case 1 illustrated in FIG. 10A and the handover case 3 illustrated in FIG. 10C, feeder links are pre-established between the terrestrial base stations and satellites, so feeder link switching may not be performed. On the other hand, in the handover case 2 illustrated in FIG. 10B, the terrestrial base station connected to the satellite may be changed. That is, the handover case 2 may be regarded as involving feeder link switching.

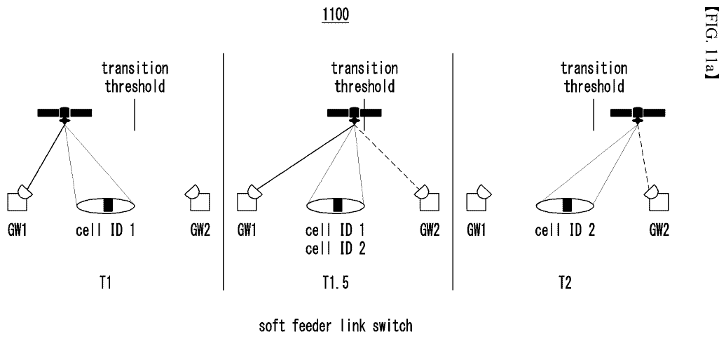

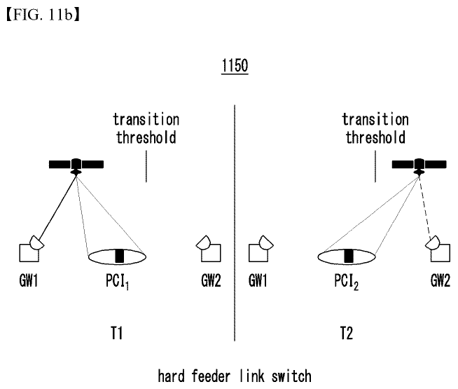

FIG. 11A and FIG. 11B are conceptual diagrams describing exemplary embodiments of a feeder link switching method in NTN.

As shown in FIGS. 11A and 11B, a communication system may be configured to include an NTN and/or a TN. For example, the communication system may include an NTN configured to provide services to a predetermined coverage, including one or more satellites and one or more gateways. Here, the NTN may be identical to or similar to at least one of the exemplary embodiments of the NTN described with reference to FIGS. 1A to 7B. Hereinafter, in describing exemplary embodiments of a feeder link switching method in the NTN with reference to FIGS. 11A and 11B, descriptions redundant with those described with reference to FIGS. 1 to 10C may be omitted.

In the NTN, a feeder link may refer to a link between a satellite and an NTN gateway (or terrestrial base station). In a non-GEO satellite-based NTN environment, a connection of the satellite with the NTN gateway may be switched to another NTN gateway depending on movement of the satellite. This may be referred to as a ‘feeder link switch’ or a ‘feeder link switchover’.

The feeder link switchover may include a soft feeder link switchover in which connections between the satellite and multiple NTN gateways can be temporarily maintained during a feeder link switch, and a hard feeder link switchover in which a connection between a satellite and only one NTN gateway can be maintained during a feeder link switch. A radio link interruption may occur during a hard feeder link switchover process.

In an exemplary embodiment of the soft feeder link switch illustrated in FIG. 11A, the feeder link switch may be performed based on a predetermined transition threshold. Here, the satellite may be connected with one gateway (i.e. GW1) in a time T1. In a time T1.5 when the soft feeder link switch is performed, the connection between the satellite and the GW1 and a connection between the satellite and a GW2 may be temporarily maintained simultaneously. In a time T2 when the soft feeder link switch is completed, only the connection between the satellite and the GW2 may be maintained.

In an exemplary embodiment of the hard feeder link switch illustrated in FIG. 11B, the feeder link switch may be performed based on a predetermined transition threshold. Here, the satellite may be connected to one gateway (i.e. GW1) in a time T1. In a time T2 when the hard feeder link switch is completed, the satellite and only the GW2 may be connected.

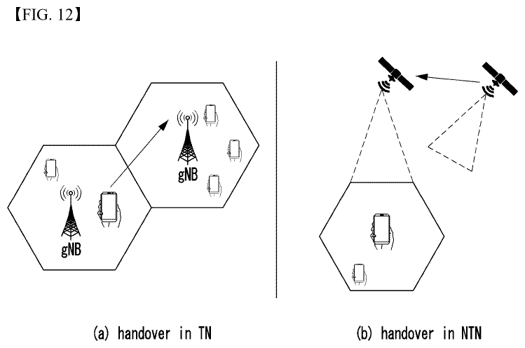

FIG. 12 is a conceptual diagram describing a difference between a handover in TN and a handover in NTN.

As shown in FIG. 12, a communication system may be configured to include an NTN and/or a TN. For example, the communication system may include an NTN configured to provide services to a predetermined coverage, including one or more satellites and one or more gateways. Here, the NTN may be identical to or similar to at least one of the exemplary embodiments of the NTN described with reference to FIGS. 1A to 7B. Hereinafter, in describing a difference between a handover in TN and a handover in NTN with reference to FIG. 12, descriptions redundant with those described with reference to FIGS. 1 to 11B may be omitted.

As shown in (a) of FIG. 12, in a handover process in the TN environment, radio resources such as BWP(s) of a terminal for which a handover is requested may be newly configured by a target base station, and information on the newly configured BWP(s) may be delivered to the terminal through a serving base station. The terminal may use the delivered BWP configuration information to proceed with a random access channel (RACH) process and a subsequent connection establishment process with the target base station.

As shown in (b) of FIG. 12, in the NTN, a handover may occur due to movement of a satellite or NTN cell, not due to movement of a terminal. Therefore, the handover in the NTN environment may be performed in a different manner from the handover in the TN environment. For example, when a handover occurs due to a new satellite entering a service area of an existing satellite, it may be preferable for the new satellite to maintain the same BWP configuration of the terminal configured by the existing satellite. Handover techniques that can improve the efficiency of BWP configuration and operations in the NTN environment may be required.

For example, in an exemplary embodiment of a communication system including an NTN, during a handover process, a target cell may configure the same BWP configurations as BWP configurations configured for the terminal in the existing source cell. Accordingly, instead of signaling all information on the BWP configurations, the target cell may signal only whether to use the same BWP configurations as before. This may minimize signaling overhead. In addition, BWP reconfiguration and BWP switching at the terminal may minimized.

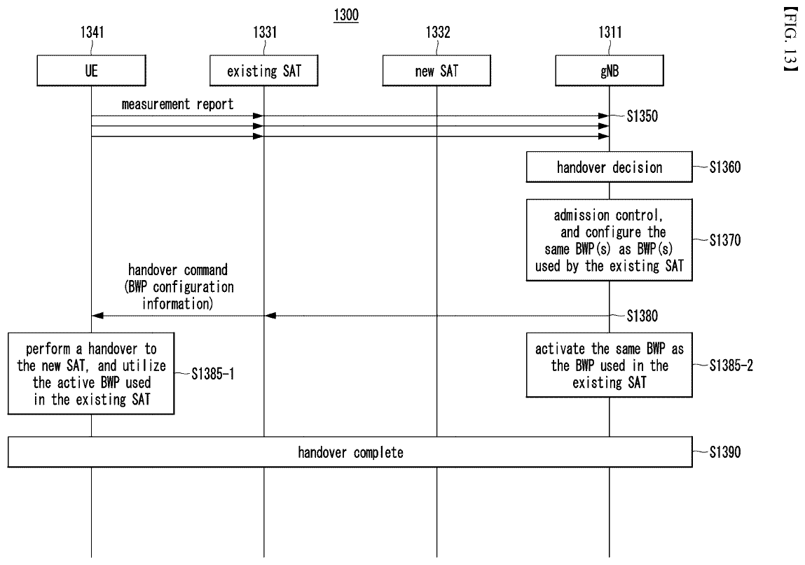

FIG. 13 is a sequence chart describing a first exemplary embodiment of a resource management method in a communication system.

As shown in FIG. 13, a communication system may be configured to include an NTN and/or a TN. For example, the communication system may include an NTN configured to provide services to a predetermined coverage, including one or more satellites and one or more gateways. Here, the NTN may be identical to or similar to at least one of the exemplary embodiments of the NTN described with reference to FIGS. 1A to 7B. Hereinafter, in describing the first exemplary embodiment of the resource management method in the communication system with reference to FIG. 13, descriptions redundant with those described with reference to FIGS. 1 to 12 may be omitted.

In the first exemplary embodiment of the resource management method in the communication system, the communication system 1300 including an NTN may support a handover according to the handover case 1 described with reference to FIG. 10A. The handover case 1 may correspond to an exemplary embodiment of inter-satellite/intra-gNB handover. Cell movement (or change) according to the handover case 1 may also be referred to as ‘cell switching’ or ‘service link switching’.

In the handover case 1, a UE 1341 may perform a handover from an existing satellite (SAT) 1331 (i.e. existing serving satellite) to a new SAT 1332 (i.e. target satellite). Here, the existing SAT 1331 and the new SAT 1332 may be connected to the same terrestrial base station 1311 (e.g. gNB). The existing SAT 1331 and/or the new SAT 1332 may be transparent payload-based satellites.

In the handover case 1, a satellite that covers a service area where the UE 1341 is located may change due to movement of the satellite. In this case, a ‘source cell’ may refer to a cell provided by the existing SAT 1331, and a ‘target cell’ may refer to a cell provided by the new SAT 1332. The satellite that provides services to the UE 1341 may change from the existing SAT 1331 to the new SAT 1332, but the terrestrial base station 1311 may not change. In this case, signaling between a serving terrestrial base station and a target terrestrial base station through an Xn interface may not be required during the handover process. Feeder links between the terrestrial base station 1311 and the satellites (i.e. the existing SAT 1331 and the new SAT 1332) may be established in advance. During the handover process, uplink/downlink transmission may be performed through the feeder links corresponding to the respective satellites (i.e. the existing SAT 1331 and the new SAT 1332).

Specifically, the UE 1341 may perform measurement reporting to the existing SAT 1331 (i.e. source cell) (S1350). The existing SAT 1331 may receive a measurement report from the UE 1341 (S1350). The existing SAT 1331 may transmit the measurement report from the UE 1341 to the terrestrial base station 1311 (S1350).

The terrestrial base station 1311 may decide whether to perform a handover based on the measurement report (S1360). For example, the terrestrial base station 1311 may determine whether handover condition(s) are satisfied based on information such as signal strength, location, and timer identified based on the measurement report. If the handover condition(s) are satisfied, the terrestrial base station 1311 may decide a handover (S1360). In step S1360, the terrestrial base station 1311 may determine that the UE 1341 is to be handed over from the existing SAT 1331 to the new SAT 1332.

The terrestrial base station 1311 may perform admission control based on the handover decision (S1370). In step S1370, the terrestrial base station 1311 may configure radio resources such as BWP(s) for the UE 1341. In other words, in step S1370, the terrestrial base station 1311 may configure a first BWP configuration for the UE 1341. BWP(s) according to the first BWP configuration may be identical to or at least partially overlapped with BWP(s) used for serving the UE 1341 in the existing SAT 1331. That is, the BWP(s) configured by the terrestrial base station 1311 for the UE 1341 in step S1370 may be identical to or at least partially overlapped with the BWP(s) configured or allocated for the UE 1341 in the source cell of the existing SAT 1331. Here, the ‘BWP(s) configured or allocated for the UE 1341 in the source cell of the existing SAT 1331’ may mean n active BWPs configured or allocated for serving the UE 1341 in the source cell of the existing SAT 1331. Here, n may be a natural number.

The terrestrial base station 1311 may transmit a handover command message to the existing SAT 1331 (S1380). The handover command message transmitted by the terrestrial base station 1311 may include information on the first BWP configuration configured in step S1370. The information on the first BWP configuration included in the handover command message may include information on whether the BWP(s) according to the first BWP configuration are the same as the BWP(s) used for serving the UE 1341 in the source cell of the existing SAT 1331. Alternatively, the information on the first BWP configuration included in the handover command message may indicate at least some of specific details on the first BWP configuration determined in step S1370.

The existing SAT 1331 may receive the handover command message transmitted from the terrestrial base station 1311 (S1380). The existing SAT 1331 may transmit the handover command message transmitted from the terrestrial base station 1311 to the UE 1341 (S1380). Alternatively, the existing SAT 1331 may generate a new handover command message based on the handover command message transmitted from the terrestrial base station 1311 and transmit it to the UE 1341 (S1380). The UE 1341 may receive the handover command message from the existing SAT 1331.

The UE 1341 may receive the handover command message transmitted from the existing SAT 1331 (S1380). The handover command message transmitted in step S1380 may include all information required for at least the UE 1341 to access a cell of the new SAT 1332. Accordingly, the UE 1341 may access a cell of the new SAT 1332 based on the handover command message without reading system information.

The UE 1341 may perform a handover to the new SAT 1332 based on the handover command message transmitted from the existing SAT 1331 (S1385-1). In step S1385-1, the UE 1341 may perform a RACH process for the new SAT 1332. The UE 1341 may perform a connection establishment procedure for the new SAT 1332. The operations in step S1385-1 may be performed based on information on the first BWP configuration included in the handover command message.

Thereafter, a handover completion procedure may be performed (S1390). For example, the UE 1341 may transmit a handover complete message to the new SAT 1332. The new SAT 1332 may receive the handover complete message transmitted from the UE 1341 (S1390). The new SAT 1332 may transmit the handover complete message transmitted from the UE 1341 to the terrestrial base station 1311. Accordingly, the handover procedure may be completed.

Meanwhile, the UE 1341 may perform an operation for BWP activation based on the information on the first BWP configuration in step S1385-1, and may also execute and complete the handover to the new SAT 1332 in step S1390.

In step S1370, the first BWP configuration may be configured as follows:

1-1. The terrestrial base station 1311 may configure only one of the active BWPs used in the cell (i.e. source cell) of the existing SAT 1331 identically in the cell (i.e. target cell) of the new SAT 1332. Information thereon may be transmitted to the UE 1341. In this case, the remaining BWPs may be configured through a reconfiguration process in the target cell after the handover is completed in step S1390.

1-2. The terrestrial base station 1311 may attempt to configure only one of the active BWPs used in the cell (i.e. source cell) of the existing SAT 1331 identically in the cell (i.e. target cell) of the new SAT 1332, but may fail. In this case, BWP reconfiguration may be performed and information thereon may be transmitted to the UE 1341.

2-1. The terrestrial base station 1311 may configure or attempt to configure k BWPs among the active BWPs used in the cell (i.e. source cell) of the existing SAT 1331 identically in the cell (i.e. target cell) of the new SAT 1332. Information thereon may be transmitted to the UE 1341. In this case, the remaining BWPs (i.e. the remaining BWPs excluding the k BWPs) may be configured through a reconfiguration process in the target cell after the handover is completed in step S1390.

2-2. The k BWPs may be selected in the order of BWP indices.

2-3. Information on BWP(s) configured identically and BWP(s) not configured identically among the k BWPs may be transmitted to the UE 1341. For example, when k=4, information on indices of the BWP(s) configured identically among BWPs #1 to #4 may be transmitted to the UE 1341. If the BWPs #1, #3, and #4 are configured identically, information thereon (e.g. bitmap ‘1011’) may be transmitted to the UE 1341. In this case, the BWP(s) (e.g. BWP #2) not configured identically may be configured through a reconfiguration process in the target cell after the handover is completed in step S1390.

2-4. If the terrestrial base station 1311 did not configure even one of the active BWPs used in the cell (i.e. source cell) of the existing SAT 1331 identically, BWP reconfiguration may be performed and information thereon may be transmitted to the UE 1341.

In step S1370, among n active BWPs used for the serving the UE 1341 in the cell of the existing SAT 1331, k active BWPs may be identically configured for serving the UE 1341 in the cell of the new SAT 1332. Here, n may be a natural number, and k may be a natural number less than or equal to n. In other words, configuration of (n-k) active BWPs among the n active BWPs used for serving the UE 1341 in the cell of the existing SAT 1331 may not be performed in step S1370. In this case, configuration of the (n-k) active BWPs not configured in step S1370 may be performed through a reconfiguration process in the target cell. The terrestrial base station 1311 may transmit first configuration information including instructions related thereto to the UE 1341, the existing SAT 1331, the new SAT 1332, and/or the like.

The first configuration information may instruct the handover procedure for the UE 1341 to be performed based on the operations illustrated in FIG. 13. If some of the active BWPs configured for serving the UE 1341 in the existing source cell are configured for serving the UE 1341 in the target cell while the UE 1341 performs a specific (or non-specific) handover procedure, the first configuration information may instruct the configuration for the remaining active BWPs to be performed through a BWP reconfiguration procedure in the target cell.

The signaling operation of the first configuration information may be performed before, during, or after the handover procedure. For example, in the exemplary embodiment illustrated in FIG. 13, the signaling operation of the first configuration information may be performed when the UE 1341 accesses the cell of the existing SAT 1331. Alternatively, the signaling operation of the first configuration information may be performed after the handover procedure of the UE 1341 to the cell of the new SAT 1332 is triggered. Alternatively, the signaling operation of the first configuration information may be performed after the UE 1341 completes the handover to the cell of the new SAT 1332.

The first configuration information may be determined by the terrestrial base station 1311. Alternatively, the first configuration information may be determined by an entity which is an upper entity of the terrestrial base station 1311 (such as a core network, etc.). The signaling operation of the first configuration information may be performed between at least some nodes among the terrestrial base station 1311, the UE 1341, the existing SAT 1331, and the new SAT 1332.

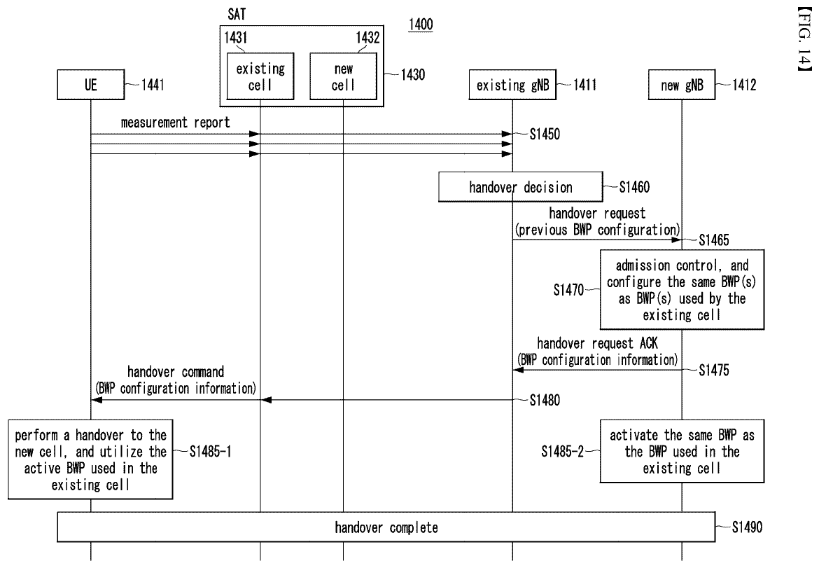

FIG. 14 is a sequence chart describing a second exemplary embodiment of a resource management method in a communication system.

As shown in FIG. 14, a communication system may be configured to include an NTN and/or a TN. For example, the communication system may include an NTN configured to provide services to a predetermined coverage, including one or more satellites and one or more gateways. Here, the NTN may be identical to or similar to at least one of the exemplary embodiments of the NTN described with reference to FIGS. 1A to 7B. Hereinafter, in describing the second exemplary embodiment of the resource management method in the communication system with reference to FIG. 14, descriptions redundant with those described with reference to FIGS. 1 to 13 may be omitted.

In the second exemplary embodiment of the resource management method in the communication system, the communication system 1400 including an NTN may support a handover according to the handover case 2 described with reference to FIG. 10B. The handover case 2 may correspond to an exemplary embodiment of an intra-satellite/inter-gNB handover.

In the handover case 2, a UE 1441 may perform a handover from an existing cell 1431 (i.e. serving cell) formed by a SAT 1430 to a new cell 1432 (i.e. target cell) by the SAT 1430. Here, the existing cell 1431 and the new cell 1432 may be connected to different terrestrial base stations 1411 and 1412 (e.g. gNBs). The existing cell 1431 and/or the new cell 1432 may be formed by the transparent payload-based satellite.

In the handover case 2, a satellite cell that covers a service area where the UE 1441 is located may be changed. Specifically, the satellite (i.e. SAT 1430) that covers the service area where the UE 1441 is located is the same, but as the terrestrial base station changes from the existing terrestrial base station 1411 to the new terrestrial base station 1412, the satellite cell may also change from the existing cell 1431 (i.e. source cell) to the new cell 1432 (i.e. target cell).

Specifically, the UE 1441 may perform measurement reporting to the existing cell 1431 (i.e. source cell) (S1450). The existing cell 1431 may receive a measurement report from the UE 1441 (S1450). The existing cell 1431 may transmit the measurement report from the UE 1441 to the existing terrestrial base station 1411 (S1450).

The existing terrestrial base station 1411 may decide whether to perform a handover based on the measurement report (S1460). For example, the existing terrestrial base station 1411 may determine whether handover condition(s) are satisfied based on information such as signal strength, location, and timer identified based on the measurement report. If the handover condition(s) are satisfied, the existing terrestrial base station 1411 may decide a handover (S1460). In step S1460, the existing terrestrial base station 1411 may determine that the UE 1441 is to be handed over from the existing cell 1431 to the new cell 1432.

The existing terrestrial base station 1411 may transmit a handover request message to the new terrestrial base station 1412 based on the handover decision (S1465). Here, the handover request may include information on BWP(s) used for serving the UE 1441 in the existing cell 1431. The new terrestrial base station 1412 may receive the handover request message transmitted from the existing terrestrial base station 1411 (S1465).

The new terrestrial base station 1412 may perform admission control based on the handover request message transmitted from the existing terrestrial base station 1411 (S1470). In step S1470, the new terrestrial base station 1412 may configure radio resources such as BWP(s) for the UE 1441. In other words, in step S1470, the new terrestrial base station 1412 may configure a first BWP configuration for the UE 1441. BWP(s) according to the first BWP configuration may be identical to or at least partially overlapped with BWP(s) used for serving the UE 1441 in the existing cell 1431. That is, the BWP(s) configured by the new terrestrial base station 1412 for the UE 1441 in step S1470 may be identical to or at least partially overlapped with the BWP(s) configured or allocated for the UE 1441 in the existing cell 1431. Here, the ‘BWP(s) configured or allocated for the UE 1441 in the existing cell 1431’ may refer to n active BWPs configured or allocated for serving the UE 1441 in the existing cell 1431. Here, n may be a natural number.

The new terrestrial base station 1412 may transmit a handover request ACK message, which is a response to the handover request, to the existing terrestrial base station 1411 (S1475). The handover request ACK message transmitted by the new terrestrial base station 1412 may include information on the first BWP configuration configured in step S1470. The information on the first BWP configuration included in the handover request ACK message may include information on whether the BWP(s) according to the first BWP configuration are the same as the BWP(s) used for serving the UE 1441 in the existing cell 1431. Alternatively, the information on the first BWP configuration included in the handover command message may indicate at least some of specific details on the first BWP configuration determined in step S1470.

The existing terrestrial base station 1411 may transmit a handover command message to the existing cell 1431 based on the received handover request ACK message (S1480). The handover command message may include information on the first BWP configuration configured in step S1470. The information on the first BWP configuration included in the handover command message may include information on whether the BWP(s) according to the first BWP configuration are the same as the BWP(s) used for serving the UE 1441 in the existing cell 1431. Alternatively, the information on the first BWP configuration included in the handover command message may indicate at least some of specific details on the first BWP configuration determined in step S1470.

The existing cell 1431 may receive the handover command message transmitted from the existing terrestrial base station 1411 (S1480). The existing cell 1431 may transmit the handover command message transmitted from the existing terrestrial base station 1411 to the UE 1441 (S1480). Alternatively, the existing cell 1431 may generate a new handover command message based on the handover command message transmitted from the existing terrestrial base station 1411 and transmit it to the UE 1441 (S1480). The UE 1441 may receive the handover command message from the existing cell 1431.

The UE 1441 may receive the handover command message transmitted from the existing cell 1431 (S1480). The handover command message transmitted in step S1480 may include all information required for at least the UE 1441 to access the new cell 1432. Accordingly, the UE 1441 may access the new cell 1432 based on the handover command message without reading system information.

The UE 1441 may perform a handover to the new cell 1432 based on the handover command message transmitted from the existing cell 1431 (S1485-1). In step S1485-1, the UE 1441 may perform a RACH process for the new cell 1432. The UE 1441 may perform a connection establishment procedure for the new cell 1432. The operations in step S1485-1 may be performed based on information on the first BWP configuration included in the handover command message.

Thereafter, a handover completion procedure may be performed (S1490). For example, the UE 1441 may transmit a handover complete message to the new cell 1432. The new cell 1432 may receive the handover complete message transmitted from the UE 1441 (S1490). The new SAT 1432 may transmit the handover complete message transmitted from the UE 1441 to the new terrestrial base station 1412. Accordingly, the handover procedure may be completed.

Meanwhile, the UE 1441 may perform an operation for BWP activation based on the information on the first BWP configuration in step S1485-1, and may also execute and complete the handover to the new cell 1432 in step S1490.

In step S1470, the first BWP configuration may be configured as follows:

1-1. The new terrestrial base station 1412 may configure only one of the active BWPs used in the existing cell 1431 (i.e. source cell) identically in the new cell 1432 (i.e. target cell). Information thereon may be transmitted to the UE 1441. In this case, the remaining BWPs may be configured through a reconfiguration process in the target cell after the handover is completed in step S1490.

1-2. The new terrestrial base station 1412 may attempt to configure only one of the active BWPs used in the existing cell 1431 (i.e. source cell) identically in the new cell 1432 (i.e. target cell), but may fail. In this case, BWP reconfiguration may be performed and information thereon may be transmitted to the UE 1441.

2-1. The new terrestrial base station 1412 may configure or attempt to configure k BWPs among the active BWPs used in the existing cell 1431 (i.e. source cell) identically in the new cell 1432 (i.e. target cell). Information thereon may be transmitted to the UE 1441. In this case, the remaining BWPs (i.e. the remaining BWPs excluding the k BWPs) may be configured through a reconfiguration process in the target cell after the handover is completed in step S1490.

2-2. The k BWPs may be selected in the order of BWP indices.

2-3. Information on BWP(s) configured identically and BWP(s) not configured identically among the k BWPs may be transmitted to the UE 1441. For example, when k=4, information on indices of the BWP(s) configured identically among BWPs #1 to #4 may be transmitted to the UE 1441. For example, if the BWPs #1, #3, and #4 are configured identically, information thereon (e.g. bitmap ‘1011’) may be transmitted to the UE 1441. In this case, the BWP(s) (e.g. BWP #2) not configured identically may be configured through a reconfiguration process in the target cell after the handover is completed in step S1490.

2-4. If the new terrestrial base station 1412 did not configure even one of the active BWPs used in the existing cell 1431 (i.e. source cell) identically, BWP reconfiguration may be performed and information thereon may be transmitted to the UE 1441.

In step S1470, among n active BWPs used for serving the UE 1341 in the existing cell 1431, k active BWPs may be identically configured for serving the UE 1441 in the new cell 1432. Here, n may be a natural number, and k may be a natural number less than or equal to n. In other words, configuration of (n-k) active BWPs among the n active BWPs used for serving the UE 1441 in the existing cell 1431 may not be performed in step S1470. In this case, configuration of the (n-k) active BWPs not configured in step S1470 may be performed through a reconfiguration process in the target cell. The existing terrestrial base station 1411 or the new terrestrial base station 1412 may transmit first configuration information including instructions related thereto to the UE 1441, the existing cell 1431, the new cell 1432, and/or the like.

The first configuration information may instruct the handover procedure for the UE 1441 to be performed based on the operations illustrated in FIG. 14. If some of the active BWPs configured for serving the UE 1441 in the existing source cell are configured for serving the UE 1441 in the target cell while the UE 1441 performs a specific (or non-specific) handover procedure, the first configuration information may instruct the configuration for the remaining active BWPs to be performed through a BWP reconfiguration procedure in the target cell.

The signaling operation of the first configuration information may be performed before, during, or after the handover procedure. For example, in the exemplary embodiment illustrated in FIG. 14, the signaling operation of the first configuration information may be performed when the UE 1441 accesses the existing cell 1431. Alternatively, the signaling operation of the first configuration information may be performed after the handover procedure of the UE 1441 to the new cell 1432 is triggered. Alternatively, the signaling operation of the first configuration information may be performed after the UE 1441 completes the handover to the new cell 1432.

The first configuration information may be determined by the existing terrestrial base station 1411 or the new terrestrial base station 1412. Alternatively, the first configuration information may be determined by an entity which is an upper entity of the existing terrestrial base station 1411 and/or new terrestrial base station 1412 (such as a core network, etc.). The signaling operation of the first configuration information may be performed between at least some nodes among the existing terrestrial base station 1411, the new terrestrial base station 1412, the UE 1441, the existing cell 1431, and the new cell 1432.

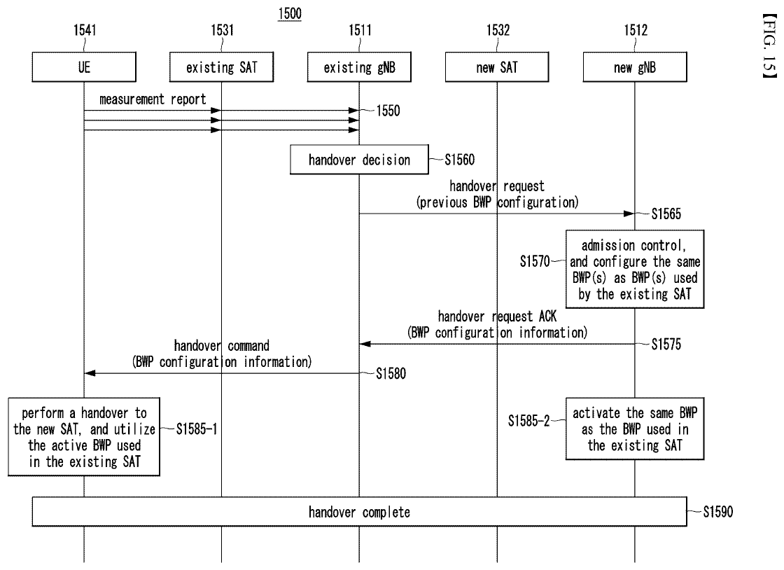

FIG. 15 is a sequence chart describing a third exemplary embodiment of a resource management method in a communication system.

As shown in FIG. 15, a communication system may be configured to include an NTN and/or a TN. For example, the communication system may include an NTN configured to provide a service to a predetermined coverage, including one or more satellites and one or more gateways. Here, the NTN may be identical to or similar to at least one of the exemplary embodiments of the NTN described with reference to FIGS. 1A to 7B. Hereinafter, in describing the third exemplary embodiment of the resource management method in the communication system with reference to FIG. 15, descriptions redundant with those described with reference to FIGS. 1 to 14 may be omitted.

In the third exemplary embodiment of the resource management method in the communication system, the communication system 1500 including an NTN may support a handover according to the handover case 3 described with reference to FIG. 10C. The handover case 3 may correspond to an exemplary embodiment of inter-access handover. The handover case 3 may correspond to an exemplary embodiment of an inter-satellite/inter-gNB handover.

In the handover case 3, a UE 1541 may perform a handover from a cell (i.e. serving cell) formed by an existing SAT 1531 to a cell (i.e. target cell) formed by a new SAT 1532. Here, the existing SAT 1531 and the new SAT 1532 may be connected to different terrestrial base stations 1511 and 1512 (e.g. gNBs). The existing SAT 1531 and/or the new SAT 1532 may be transparent payload-based satellites.

In the handover case 3, a satellite cell that covers a service area where the UE 1541 is located may be changed. Specifically, the satellite (i.e. SAT 1530) that covers the service area where the UE 1541 is located is the same, but as the terrestrial base station changes from the existing terrestrial base station 1511 to the new terrestrial base station 1512, the satellite cell may also change from the cell (i.e. source cel) of the existing SAT 1531 to the cell (i.e. target cell) of the new SAT 1532.

Specifically, the UE 1541 may perform measurement reporting to the existing SAT 1531 (i.e. source cell) (S1550). The existing SAT 1531 may receive a measurement report from the UE 1541 (S1450). The existing SAT 1531 may transmit the measurement report from the UE 1441 to the existing terrestrial base station 1411 (S1550).

The existing terrestrial base station 1511 may decide whether to perform a handover based on the measurement report (S1560). For example, the existing terrestrial base station 1511 may determine whether handover condition(s) are satisfied based on information such as signal strength, location, and timer identified based on the measurement report. If the handover condition(s) are satisfied, the existing terrestrial base station 1511 may decide a handover (S1560). In step S1560, the existing terrestrial base station 1511 may determine that the UE 1541 is to be handed over from the existing SAT 1531 to the new SAT 1532.

The existing terrestrial base station 1511 may transmit a handover request message to the new terrestrial base station 1512 based on the handover decision (S1565). Here, the handover request may include information on BWP(s) used for serving the UE 1541 in the existing SAT 1531. The new terrestrial base station 1512 may receive the handover request message transmitted from the existing terrestrial base station 1511 (S1565).

The new terrestrial base station 1512 may perform admission control based on the handover request message transmitted from the existing terrestrial base station 1511 (S1570). In step S1570, the new terrestrial base station 1512 may configure radio resources such as BWP(s) for the UE 1541. In other words, in step S1570, the new terrestrial base station 1512 may configure a first BWP configuration for the UE 1541. BWP(s) according to the first BWP configuration may be identical to or at least partially overlapped with BWP(s) used for serving the UE 1541 in the existing SAT 1531. That is, the BWP(s) configured by the new terrestrial base station 1512 for the UE 1541 in step S1570 may be identical to or at least partially overlapped with the BWP(s) configured or allocated for the UE 1541 in the existing SAT 1531. Here, the ‘BWP(s) configured or allocated for the UE 1541 in the existing SAT 1531’ may refer to n active BWPs configured or allocated for serving the UE 1341 in the existing SAT 1531. Here, n may be a natural number.

The new terrestrial base station 1512 may transmit a handover request ACK message, which is a response to the handover request, to the existing terrestrial base station 1511 (S1575). The handover request ACK message transmitted by the new terrestrial base station 1512 may include information on the first BWP configuration configured in step S1570. The information on the first BWP configuration included in the handover request ACK message may include information on whether the BWP(s) according to the first BWP configuration are the same as the BWP(s) used for serving the UE 1541 in the existing SAT 1531. Alternatively, the information on the first BWP configuration included in the handover command message may indicate at least some of specific details on the first BWP configuration determined in step S1570.

The existing terrestrial base station 1511 may transmit a handover command message to the existing SAT 1531 based on the received handover request ACK message (S1580). The handover command message may include information on the first BWP configuration configured in step S1570. The information on the first BWP configuration included in the handover command message may include information on whether the BWP(s) according to the first BWP configuration are the same as the BWP(s) used for serving the UE 1541 in the existing SAT 1531. Alternatively, the information on the first BWP configuration included in the handover command message may indicate at least some of specific details on the first BWP configuration determined in step S1570.

The existing SAT 1531 may receive the handover command message transmitted from the existing terrestrial base station 1511 (S1580). The existing SAT 1531 may transmit the handover command message transmitted from the existing terrestrial base station 1511 to the UE 1541 (S1580). Alternatively, the existing SAT 1531 may generate a new handover command message based on the handover command message transmitted from the existing terrestrial base station 1511 and transmit it to the UE 1541 (S1580). The UE 1541 may receive the handover command message from the existing SAT 1531.

The UE 1541 may receive the handover command message transmitted from the existing SAT 1531 (S1580). The handover command message transmitted in step S1580 may include all information required for at least the UE 1541 to access the cell of the new SAT 1532. Accordingly, the UE 1541 may access the cell of the new SAT 1532 based on the handover command message without reading system information.

The UE 1541 may perform a handover to the new SAT 1532 based on the handover command message transmitted from the existing SAT 1531 (S1585-1). In step S1585-1, the UE 1541 may perform a RACH process for the new SAT 1532. The UE 1541 may perform a connection establishment procedure for the new SAT 1532. The operations in step S1585-1 may be performed based on information on the first BWP configuration included in the handover command message.

Thereafter, a handover completion procedure may be performed (S1590). For example, the UE 1541 may transmit a handover complete message to the new SAT 1532. The new SAT 1532 may receive the handover complete message transmitted from the UE 1541 (S1590). The new SAT 1532 may transmit the handover complete message transmitted from the UE 1541 to the new terrestrial base station 1512. Accordingly, the handover procedure may be completed.

Meanwhile, the UE 1541 may perform an operation for BWP activation based on the information on the first BWP configuration in step S1585-1, and may also execute and complete the handover to the new SAT 1532 in step S1590.

In step S1570, the first BWP configuration may be configured as follows:

1-1. The new terrestrial base station 1512 may configure only one of the active BWPs used in the cell (i.e. source cell) of the existing SAT 1531 identically in the cell (i.e. target cell) of the new SAT 1532. Information thereon may be transmitted to the UE 1541. In this case, the remaining BWPs may be configured through a reconfiguration process in the target cell after the handover is completed in step S1590.

1-2. The new terrestrial base station 152 may attempt to configure only one of the active BWPs used in the cell (i.e. source cell) of the existing SAT 1531 identically in the cell (i.e. target cell) of the new SAT 1532, but may fail. In this case, BWP reconfiguration may be performed and information thereon may be transmitted to the UE 1541.

2-1. The new terrestrial base station 1512 may configure or attempt to configure k BWPs among the active BWPs used in the cell (i.e. source cell) of the existing SAT 1531 identically in the cell (i.e. target cell) of the new SAT 1532. Information thereon may be transmitted to the UE 1541. In this case, the remaining BWPs (i.e. the remaining BWPs excluding the k BWPs) may be configured through a reconfiguration process in the target cell after the handover is completed in step S1590.

2-2. The k BWPs may be selected in the order of BWP indices.

2-3. Information on BWP(s) configured identically and BWP(s) not configured identically among the k BWPs may be transmitted to the UE 1541. For example, when k=4, information on indices of the BWP(s) configured identically among BWPs #1 to #4 may be transmitted to the UE 1541. For example, if the BWPs #1, #3, and #4 are configured identically, information thereon (e.g. bitmap ‘1011’) may be transmitted to the UE 1541. Here, in this case, the BWP(s) (e.g. BWP #2) not configured identically may be configured through a reconfiguration process in the target cell after the handover is completed in step S1590.

2-4. If the new terrestrial base station 1512 did not configure even one of the active BWPs used in the cell (i.e. source cell) of the existing SAT 1531 identically, BWP reconfiguration may be performed and information thereon may be transmitted to the UE 1541.

In step S1570, among n active BWPs used for serving the UE 1541 in the cell of the existing SAT 1531, k active BWPs may be identically configured for serving the UE 1541 in the cell of the new SAT 1532. Here, n may be a natural number, and k may be a natural number less than or equal to n. In other words, configuration of (n-k) active BWPs among the n active BWPs used for serving the UE 1541 in the cell of the existing SAT 1531 may not be performed in step S1570. In this case, configuration of the (n-k) active BWPs not configured in step S1570 may be performed through a reconfiguration process in the target cell. The existing terrestrial base station 1511 or the new terrestrial base station 1512 may transmit first configuration information including instructions related thereto to the UE 1541, the existing SAT 1531, the new SAT 1532, and/or the like.

The first configuration information may instruct the handover procedure for the UE 1541 to be performed based on the operations illustrated in FIG. 15. If some of the active BWPs configured for serving the UE 1541 in the existing source cell are configured for serving the UE 1541 in the target cell while the UE 1541 performs a specific (or non-specific) handover procedure, the first configuration information may instruct the configuration for the remaining active BWPs to be performed through a BWP reconfiguration procedure in the target cell.

The signaling operation of the first configuration information may be performed before, during, or after the handover procedure. For example, in the exemplary embodiment illustrated in FIG. 15, the signaling operation of the first configuration information may be performed when the UE 1541 accesses the existing SAT 1531. Alternatively, the signaling operation of the first configuration information may be performed after the handover procedure of the UE 1541 to the cell of the new SAT 1532 is triggered. Alternatively, the signaling operation of the first configuration information may be performed after the UE 1541 completes the handover to the cell of the new SAT 1532.

The first configuration information may be determined by the existing terrestrial base station 1511 or the new terrestrial base station 1512. Alternatively, the first configuration information may be determined by an entity which is in an upper entity of the existing terrestrial base station 1511 and/or new terrestrial base station 1512 (such as a core network, etc.). The signaling operation of the first configuration information may be performed between at least some nodes among the existing terrestrial base station 1511, the new terrestrial base station 1512, the UE 1541, the existing SAT 1531, and the new SAT 1532.

According to exemplary embodiments of a resource management method and apparatus in a communication system including an NTN, a terminal connected to the NTN may move from a first satellite cell to a second satellite cell. Here, as the terminal moves from the first satellite cell to the second satellite cell, at least a portion of BWPs configured for the terminal in the first satellite cell may be identically configured in the second satellite cell. As BWP(s) that partially overlap with the previously used ones are configured during the terminal's cell movement process, overhead of configuring BWPs and signaling procedures for BWP information can be significantly reduced. Accordingly, the efficiency of the terminal's cell movement process can be improved.

The operations of the method according to the exemplary embodiment of the present disclosure can be implemented as a computer readable program or code in a computer readable recording medium. The computer readable recording medium may include all kinds of recording apparatus for storing data which can be read by a computer system. Furthermore, the computer readable recording medium may store and execute programs or codes which can be distributed in computer systems connected through a network and read through computers in a distributed manner.

The computer readable recording medium may include a hardware apparatus which is specifically configured to store and execute a program command, such as a ROM, RAM or flash memory. The program command may include not only machine language codes created by a compiler, but also high-level language codes which can be executed by a computer using an interpreter.

Although some aspects of the present disclosure have been described in the context of the apparatus, the aspects may indicate the corresponding descriptions according to the method, and the blocks or apparatus may correspond to the steps of the method or the features of the steps. Similarly, the aspects described in the context of the method may be expressed as the features of the corresponding blocks or items or the corresponding apparatus. Some or all of the steps of the method may be executed by (or using) a hardware apparatus such as a microprocessor, a programmable computer or an electronic circuit. In some embodiments, one or more of the most important steps of the method may be executed by such an apparatus.

In some exemplary embodiments, a programmable logic device such as a field-programmable gate array may be used to perform some or all of functions of the methods described herein. In some exemplary embodiments, the field-programmable gate array may be operated with a microprocessor to perform one of the methods described herein. In general, the methods are preferably performed by a certain hardware device.

The description of the disclosure is merely exemplary in nature and, thus, variations that do not depart from the substance of the disclosure are intended to be within the scope of the disclosure. Such variations are not to be regarded as a departure from the spirit and scope of the disclosure. Thus, it will be understood by those of ordinary skill in the art that various changes in form and details may be made without departing from the spirit and scope as defined by the following claims.

1. An operation method of a first terrestrial base station, comprising:
receiving, from a first satellite forming a first satellite cell to which a first terminal is connected, a first measurement report reported by the first terminal;
determining, based on the first measurement report, that the first terminal is to connect to a second satellite cell formed by a second satellite connected to the first terrestrial base station;
identifying n bandwidth parts (BWPs) configured for the first terminal in the first satellite cell;
attempting to configure a first BWP group including at least one BWP among the n BWPs to be used for serving the first terminal in the second satellite cell; and
transmitting, to the first satellite, first configuration information including first BWP configuration information generated based on a result of the attempting and information instructing the first terminal to connect to the second satellite cell,
wherein n is a natural number.

2. The operation method according to claim 1, wherein the first BWP group includes one first BWP, and the attempting comprises:
attempting to configure the first BWP to be used for serving the first terminal in the second satellite cell; and
in response to the first BWP being successfully configured to be used for serving the first terminal, generating the first BWP configuration information including information indicating that the first BWP among the n BWPs configured for the first terminal in the first satellite cell is configured for serving the first terminal in the second satellite cell.

3. The operation method according to claim 2, further comprising: transmitting, to the first terminal, second configuration information instructing the first terminal to perform a BWP reconfiguration procedure with the second satellite cell for (n−1) BWPs excluding the first BWP among the n BWPs.

4. The operation method according to claim 1, wherein the first BWP group includes one first BWP, and the attempting comprises:
attempting to configure the first BWP to be used for serving the first terminal in the second satellite cell;
in response to the first BWP failing to be configured to be used for serving the first terminal, performing BWP reconfiguration; and
generating the first BWP configuration information indicating a result of the BWP reconfiguration.

5. The operation method according to claim 1, wherein the first BWP group includes m BWPs, and the attempting comprises:
attempting to configure k BWPs to be used for serving the first terminal in the second satellite cell; and
in response to the k BWPs being successfully configured to be used for serving the first terminal, generating the first BWP configuration information including information on the k BWPs,
wherein m is a natural number less than or equal to n, and k is a natural number less than or equal to m.

6. The operation method according to claim 5, wherein the m BWPs are first to m-th BWPs selected based on BWP indices from among the n BWPs, and the first BWP configuration information includes respective indices of the first to m-th BWPs and mapping information of the first to m-th BWPs for the k BWPs.

7. The operation method according to claim 5, further comprising: transmitting, to the first terminal, third configuration information instructing the first terminal to perform a BWP reconfiguration procedure with the second satellite cell for (n-k) BWPs excluding the k BWPs among the n BWPs.

8. An operation method of a first terrestrial base station, comprising:
receiving, from a second terrestrial base station connected to a first satellite, a handover request for a first terminal connected to a first satellite cell formed by the first satellite connected to the first terrestrial base station;
accepting a handover of the first terminal to a second satellite cell formed by the first satellite, based on the handover request;
identifying n bandwidth parts (BWPs) configured for the first terminal in the first satellite cell, based on the handover request;
attempting to configure a first BWP group including at least one BWP among the n BWPs to be used for serving the first terminal in the second satellite cell; and
transmitting a first response to the second terrestrial base station, the first response including first BWP configuration information generated based on a result of the attempting and information indicating that the handover request for the first terminal is accepted,
wherein n is a natural number.

9. The operation method according to claim 8, wherein the first BWP group includes one first BWP, and the attempting comprises:
attempting to configure the first BWP to be used for serving the first terminal in the second satellite cell; and
in response to the first BWP being successfully configured to be used for serving the first terminal, generating the first BWP configuration information including information indicating that the first BWP among the n BWPs configured for the first terminal in the first satellite cell is configured for serving the first terminal in the second satellite cell.

10. The operation method according to claim 9, further comprising: transmitting, to the first terminal, second configuration information instructing the first terminal to perform a BWP reconfiguration procedure with the second satellite cell for (n−1) BWPs excluding the first BWP among the n BWPs.

11. The operation method according to claim 8, wherein the first BWP group includes one first BWP, and the attempting comprises:
attempting to configure the first BWP to be used for serving the first terminal in the second satellite cell;
in response to the first BWP failing to be configured to be used for serving the first terminal, performing BWP reconfiguration; and
generating the first BWP configuration information indicating a result of the BWP reconfiguration.

12. The operation method according to claim 8, wherein the first BWP group includes m BWPs, and the attempting comprises:
attempting to configure k BWPs to be used for serving the first terminal in the second satellite cell; and
in response to the k BWPs being successfully configured to be used for serving the first terminal, generating the first BWP configuration information including information on the k BWPs,
wherein m is a natural number less than or equal to n, and k is a natural number less than or equal to m.

13. The operation method according to claim 12, wherein the m BWPs are first to m-th BWPs selected based on BWP indices from among the n BWPs, and the first BWP configuration information includes respective indices of the first to m-th BWPs and mapping information of the first to m-th BWPs for the k BWPs.

14. The operation method according to claim 12, further comprising: transmitting, to the first terminal, third configuration information instructing the first terminal to perform a BWP reconfiguration procedure with the second satellite cell for (n-k) BWPs excluding the k BWPs among the n BWPs.

15. An operation method of a first terrestrial base station, comprising:
receiving, from a second terrestrial base station, a handover request for a first terminal connected to a first satellite cell formed by a first satellite connected to the second terrestrial base station;
accepting a handover of the first terminal to a second satellite cell formed by a second satellite connected to the second terrestrial base station, based on the handover request;
identifying n bandwidth parts (BWPs) configured for the first terminal in the first satellite cell, based on the handover request;
attempting to configure a first BWP group including at least one BWP among the n BWPs to be used for serving the first terminal in the second satellite cell; and
transmitting a first response to the second terrestrial base station, the first response including first BWP configuration information generated based on a result of the attempting and information indicating that the handover request for the first terminal is accepted,
wherein n is a natural number.

16. The operation method according to claim 15, wherein the first BWP group includes one first BWP, and the attempting comprises:
attempting to configure the first BWP to be used for serving the first terminal in the second satellite cell; and
in response to the first BWP being successfully configured to be used for serving the first terminal, generating the first BWP configuration information including information indicating that the first BWP among the n BWPs configured for the first terminal in the first satellite cell is configured for serving the first terminal in the second satellite cell.

17. The operation method according to claim 16, further comprising: transmitting, to the first terminal, second configuration information instructing the first terminal to perform a BWP reconfiguration procedure with the second satellite cell for (n−1) BWPs excluding the first BWP among the n BWPs.

18. The operation method according to claim 15, wherein the first BWP group includes one first BWP, and the attempting comprises:
attempting to configure the first BWP to be used for serving the first terminal in the second satellite cell;
in response to the first BWP failing to be configured to be used for serving the first terminal, performing BWP reconfiguration; and
generating the first BWP configuration information indicating a result of the BWP reconfiguration.

19. The operation method according to claim 15, wherein the first BWP group includes m BWPs, and the attempting comprises:
attempting to configure k BWPs to be used for serving the first terminal in the second satellite cell; and
in response to the k BWPs being successfully configured to be used for serving the first terminal, generating the first BWP configuration information including information on the k BWPs,
wherein m is a natural number less than or equal to n, and k is a natural number less than or equal to m.

20. The operation method according to claim 19, wherein the m BWPs are first to m-th BWPs selected based on BWP indices from among the n BWPs, and the first BWP configuration information includes respective indices of the first to m-th BWPs and mapping information of the first to m-th BWPs for the k BWPs.
